(19) United States
(12) Patent Application Publication
(10) Pub. No.: US 2025/0250182 A1
(43) Pub. Date: Aug. 7, 2025

(54) SYSTEM AND METHODS FOR EXTRACTING WATER FROM AN AQUEOUS SOLUTION

(71) Applicant: IONIC WATER TECHNOLOGIES, INC., Hamilton, NJ (US)

(72) Inventors: George W. ADAMSON, Hamilton, NJ (US); Annie MCCULLOUGH, Hamilton, NJ (US); Robert Chris HOLLEY, Hamilton, NJ (US)

(21) Appl. No.: 18/862,503

(22) PCT Filed: May 12, 2023
(86) PCT No.: PCT/US2023/022050

§ 371 Date: Nov. 1, 2024

Related U.S. Application Data
(60) Provisional application No. 63/341,794, filed on May 13, 2022.

(51) Int. Cl. C02F 1/26; C02F 1/00; C02F 1/02; C02F 1/44; C02F 103/08

(52) U.S. Cl. CPC C02F 1/265; C02F 1/001; C02F 1/02; C02F 1/44; C02F 2103/08

(57) ABSTRACT

Systems and methods for extracting water from aqueous solutions are described herein. In one aspect, the present disclosure provides a system including a source of aqueous solution and an extraction loop. The extraction loop comprises a conduit. The conduit comprises a semi-permeable segment and a non-permeable segment. The conduit is configured to permit the flow of at least a portion of an extraction agent through the semi-permeable segment and the non-permeable segment. At least a portion of the semi-permeable segment contacts the source of aqueous solution and is configured to permit a portion of the aqueous solution to contact at least a portion of the extraction agent.

### CROSS REFERENCE TO RELATED APPLICATION

This application claims priority to U.S. provisional application No. 63/341,794, filed on May 13, 2022, which is incorporated by reference in its entirety.

### FIELD OF THE INVENTION

The present invention relates to systems and methods for extracting water from an aqueous solution.

### BACKGROUND

Potable water and water suitable for agricultural use are essential for human life. Presently, 2.3 billion people throughout the world live in water-stressed countries. Of these 2.3 billion people, about thirty-two percent (32%) live in regions that are considered highly and/or critically water-stressed.

Aqueous solutions having high levels of salinity (e.g., seawater, brackish water, and well water) represent a potential resource for addressing water scarcity issues across the globe. However, conventional systems and methods for extracting water (e.g., potable water or water suitable for agricultural use) from aqueous solutions suffer from several drawbacks. Specifically, conventional systems and methods for extracting water from aqueous solutions are inefficient and/or too costly to be practicable. Many conventional systems and methods rely on large amounts of electricity to produce potable water. Some conventional systems and methods require the transportation of aqueous solutions over long distances, thereby increasing the inefficiencies and costs associated with producing potable water. Other conventional systems produce large amounts of brine that must be disposed of or otherwise utilized, thereby increasing costs associated with water extraction. And, some conventional systems require components (e.g., filter systems) that are expensive to maintain.

As such, there remains a need to provide improved systems and methods for extracting water from aqueous solutions.

### SUMMARY OF THE INVENTION

In one aspect, the present invention provides a system for extracting water from an aqueous solution. The system comprises a reservoir. The reservoir comprises an inlet configured to provide a feed stream including an extraction agent and an aqueous solution to the reservoir under mixing conditions, at about ambient temperature, to form a wet extraction agent phase and a raffinate phase. The aqueous solution has a concentration of sodium chloride. The reservoir also comprises a lower outlet, wherein the lower outlet is reversibly closable and configured to permit at least a portion of the raffinate phase to exit the reservoir while retaining from about 50% to about 100% by volume of the wet extraction agent phase in the reservoir. The system also comprises a heater configured to heat the wet extraction agent phase to a temperature of from about 35° C. to about 130° C. to form a heated mixture including a dry extraction agent phase and a water phase. The system further comprises an upper outlet, wherein the upper outlet fluidly communicates with a channel configured to permit at least a portion of the dry extraction agent phase to return to the feed stream.

In some embodiments, the lower outlet is spatially oriented on the reservoir so that the lower outlet is below the upper outlet. In some embodiments, the upper outlet is reversibly closable.

In some embodiments, the lower outlet comprises a reversibly closable valve. For example, the reversibly closable valve of the lower outlet comprises a solenoid configured to open the reversibly closable valve when power is supplied to the solenoid and close when power is not supplied to the solenoid. In other embodiments, the reversibly closable valve comprises a spring-operated cap, wherein the spring-operated cap is configured to assume an open position when pressure inside the reservoir reaches a threshold.

In some embodiments, the channel comprises a conduit, wherein at least a portion of the conduit comprises a semi-permeable membrane.

In some embodiments, the system further comprises a pump fluidly communicating with the upper outlet and the channel, wherein the pump is configured to move at least a portion of the dry extraction agent phase from the reservoir into the channel.

In another aspect, the present invention provides a system for extracting water from an aqueous solution. The system comprises a source of aqueous solution, wherein the aqueous solution comprises a concentration of sodium chloride. The system also comprises an extraction loop. The extraction loop comprises an extraction agent, a conduit, a heater, and a reversibly closable water outlet. The conduit comprises a semi-permeable segment and a non-permeable segment, wherein the conduit is configured to permit the flow of at least a portion of the extraction agent through the semi-permeable segment and the non-permeable segment, and wherein at least a portion of the semi-permeable segment contacts the source of aqueous solution and is configured to permit a portion of the aqueous solution to contact at least a portion of the extraction agent. The heater is in thermal communication with a portion of the extraction agent within a heated portion of the non-permeable segment. The heater is configured to heat the portion of extraction agent thermally communicating therewith from ambient temperature to a temperature of from about 35° C. to about 130° C. to form an extraction agent phase and a water phase. The reversibly closable water outlet is in fluid communication with a portion of the non-permeable segment and oriented downstream from the heater. The water outlet is configured to permit at least a portion of the water phase to exit the conduit while retaining from about 50% to about 100% by volume of the extraction agent phase in the conduit. The extraction loop is configured to return at least a portion of the extraction agent phase to the semi-permeable segment of the conduit as extraction agent.

In some embodiments, the semi-permeable segment comprises a plurality of pores having a mean pore size of from about 80 nm to about 1 μm. In some embodiments, the semi-permeable segment comprises a molecular weight cut off of from about 300 D to about 3,000 D. And, in some embodiments, the semi-permeable segment comprises a cellulose material, a polysulphone material, a polyamide material, a polyimide material, PTFE, PVDF, PEO, PPO, PVC, CPVC, PP, HDPE, PE, or any combination thereof.

In some embodiments, a portion of the non-permeable segment downstream from the heater is configured to permit the extraction agent phase to cool to a temperature of from about ambient temperature to about 34° C. before reaching the semi-permeable segment. In some embodiments, a portion of the non-permeable segment downstream from the heater comprises a tank, wherein the reversibly closable water outlet fluidly communicates with the tank, and wherein the tank fluidly communicates with the heated portion of the non-permeable segment.

In some embodiments, the system further comprises an actuator fluidly communicating with the extraction loop and configured to cycle the extraction agent and the extraction phase around the extraction loop. For example, the actuator comprises a pump.

One aspect of the invention provides a system for extracting water from an aqueous solution, wherein the system comprises an extraction loop and an extraction agent, the extraction loop comprises a membrane interface, a heater, a cooler, and a separation tank, the membrane interface comprises a semi-permeable membrane interposed between a source of aqueous solution and the extraction agent, wherein the semi-permeable membrane is configured to permit a portion of the aqueous solution to permeate through the membrane interface and mix with dry extraction agent forming wet extraction agent; the heater is a regenerative heat exchanger configured to convey heat from dry extraction agent to wet extraction agent in the extraction loop; the cooler is upstream from membrane interface and is configured to convey heat from dry extraction agent to a feed stream of aqueous solution; and the separation tank is configured to allow the wet extraction agent to settle into a bi-phasic mixture comprising a water layer and a dry extraction agent layer, wherein the separator tank comprises a water outlet.

In some embodiments, the system further comprises a pump configured to pump aqueous solution from a source of aqueous solution creating the feed stream of aqueous solution wherein the feed stream contacts the membrane interface, flows through the cooler, and is returned to the source of aqueous solution.

In some embodiments, the system further comprises a plurality of pumps configured in the extraction loop to convey wet extraction agent from the membrane interface to the heater, convey wet extraction agent from the heater to the separation tank, convey dry extraction agent from the separation tank to the cooler, and convey dry extraction agent from the cooler to the membrane interface.

In some embodiments, the heater is configured to generate a heated wet extraction agent having a temperature of from about 50° C. to about 65° C. For instance, the heater is configured to heat the wet extraction agent to a temperature of from about 50° C. to about 65° C. before the wet extraction agent reaches the separation tank.

In some embodiments, the extraction loop further comprises a solar array configured downstream from the heater and upstream from the separation tank, wherein the solar array operates cooperatively with the heater to heat the wet extraction agent.

In some embodiments, the extraction loop further comprises an extraction agent tank, wherein the extraction agent tank is downstream from the separation tank and upstream from the cooler, and the extraction agent tank comprises a drain. In some examples, the drain is configured to drain liquid from the bottom of the tank to remove any fugitive water from the extraction agent.

In some embodiments, the extraction loop further comprises a filter fluidly communicating with the water outlet of the separator tank. And, in some embodiments, the filter comprises a granulated activated carbon bed.

Other features and advantages of the invention will be apparent from the following detailed description, figures, and from the claims.

### BRIEF DESCRIPTION OF THE DRAWINGS

The following figures are provided by way of example and are not intended to limit the scope of the claimed invention.

FIG. 1 is a schematic of a system for extracting water from an aqueous solution according to one embodiment of the invention.

FIG. 2 is a schematic of a system for extracting water from an aqueous solution according to another embodiment of the invention.

FIG. 3 is a schematic of a system for extracting water from an aqueous solution according to another embodiment of the invention.

FIG. 4 is an expanded view of a semi-permeable segment of a conduit according to the system of FIG. 3.

FIG. 5 is a schematic of a system for extracting water from an aqueous solution according to another embodiment of the invention.

FIG. 6 is a schematic of a system for extracting water from an aqueous solution according to another embodiment of the invention.

### DETAILED DESCRIPTION

The present invention provides systems and methods for extracting water from an aqueous solution.

### I. DEFINITIONS

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The terms, upper, lower, above, beneath, right, left, etc. may be used herein to describe the position of various elements with relation to other elements. These terms represent the position of elements in an example configuration. However, it will be apparent to one skilled in the art that the elements may be rotated in space without departing from the present disclosure and thus, these terms should not be used to limit the scope of the present disclosure.

As used herein, when an element is referred to as being “on,” “engaged to,” “connected to,” “attached to,” or “coupled to” another element, it may be directly on, engaged, connected, attached, or coupled to the other element, or intervening elements may be present. In contrast, when an element is referred to as being “directly on,” “directly engaged to,” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “extraction agent” refers to a material that is at least substantially immiscible with aqueous solutions, capable of water absorption at a first temperature (e.g., about ambient temperature), and exhibits decreased water solubility at a second temperature (e.g., about 35° C. to about 130° C.) that is higher than the first temperature. Non-limiting examples of the extraction agents include methylamine; ethylamine; propylamine; isopropylamine; butylamine; sec-butylamine; iso-butylamine; tert-butylamine; amylamine; hexylamine; heptylamine; 1-methylhexylamine; octylamine; 1-ethylpentylamine; 2-ethylhexylamine; 2-ethylbutylamine; 2-ethyl-1-hexylamine; tert-octylamine; nonylamine; decylamine; dodecylamine; hexadecylamine; octadecylamine; dimethylamine; diethylamine; dipropylamine; di-iso-propylamine; dibutylamine; di-sec-butylamine; di-iso-butylamine; di-tert-butylamine; diisobutylamine; N,N-ethylcyclohexylamine; N-methylcyclohexylamine; N-methyl-tert-butylamine; N-methyl-iso-butylamine; N-methylpentylamine; di-allylamine; N-ethylmethylamine; N-iso-propylmethylamine; N-methylbutylamine; N-methyl-n-amylamine; N-ethyl-tert-butylamine; N-ethyl-sec-butylamine; N-ethylpropylamine; N-ethyl-iso-propylamine; N-ethyl-n-butylamine; dioctylamine; N-methyldodecylamine; propylbutylamine; N-ethylbenzylamine; 1,3-dimethylbutylamine; N,N-dimethyl-iso-propylamine; dimethylpropylamine; N,N-dimethyl-iso-butylamine; N,N-dimethyl-tert-butylamine; N,N-dimethylcyclohexylamine; N,N-dimethylethylamine; N,N-diethylmethylamine; triethylamine; di-iso-propylmethylamine; 2-(isopropylamino)ethanol; tripropylamine; trioctylamine; N,N-dimethylhexadecylamine; 1,8-diaminooctane; 1,12-diaminododecane; 1,3-dimethylamylamine; 2-aminopentane; N,N,5,5-tetramethyl-1,3-dioxan-2amine; bis[3-trimethoxysilyl)propyl]amine; octanoic acid; decanoic acid; hexanoic acid; tri-8-chlorooctylamine; trioctylamine; trioctadecylamine; or any combination thereof.

As used herein, the term “aqueous solution” refers to a solution that comprises water and has a concentration of sodium chloride. In some instances, the aqueous solution comprises a concentration of sodium chloride of from about 300 mg/L to about 45,000 mg/L. The aqueous solution may comprise, by way of non-limiting example, seawater; well water; brackish water; brine; or any combination thereof.

As used herein, the term “raffinate phase” refers to a phase comprising the aqueous solution after mixing with the extraction agent. The raffinate phase has a reduced water content and an increased concentration of sodium chloride as compared to the aqueous solution due to water absorption by the extraction agent during mixing.

As used herein, the term “wet extraction agent phase” refers to a phase comprising the extraction agent after mixing with or contacting the aqueous solution. The wet extraction agent phase has increased water content as compared to the extraction agent (or dry extraction agent) due to water absorption by the extraction agent during mixing or contacting. In some embodiments, the wet extraction agent phase has a density that is less than the density of the raffinate phase.

As used herein, the term “ambient temperature” refers to the temperature of the aqueous solution at its source. For example, the ambient temperature of an aqueous solution, wherein the aqueous solution is sea water, is the temperature of the sea water extracted from its source (i.e., the ocean or sea). In another example, the ambient temperature of an aqueous solution, wherein the aqueous solution is well water, is the temperature of the well water extracted from its source (i.e., the well).

As used herein, the term “dry extraction agent phase” refers to a phase comprising extraction agent generated by heating the wet extraction agent phase or concentrated wet extraction agent phase. The dry extraction agent phase has a reduced water content as compared to the wet extraction agent phase (or concentrated wet extraction agent phase) due to the extraction agent having reduced water solubility during heating.

As used herein, the term “extraction agent phase” refers to a phase comprising the extraction agent after heating the extraction agent in a non-permeable segment of an extraction loop.

As used herein, the term “water phase” refers to a phase comprising water generated from heating the concentrated wet extraction agent phase. In some embodiments, the water phase has a concentration of sodium chloride that is less than the aqueous solution. In some embodiments, the dry extraction agent phase has a density that is less than the density of the water phase.

As used herein, the term “hydroxyl” or “hydroxy” refers to an —OH moiety.

As used herein the term “aliphatic” encompasses the terms alkyl, alkenyl, and alkynyl, each of which being optionally substituted as set forth below.

As used herein, an “alkyl” group refers to a saturated aliphatic hydrocarbon group containing 1-12 (e.g., 1-8, 1-6, or 1-4) carbon atoms. An alkyl group can be straight or branched. Examples of alkyl groups include, but are not limited to, methyl, ethyl, propyl, isopropyl, butyl, isobutyl, sec-butyl, tert-butyl, n-pentyl, n-heptyl, or 2-ethylhexyl. An alkyl group can be substituted (i.e., optionally substituted) with one or more substituents such as halo, phospho, cycloaliphatic [e.g., cycloalkyl or cycloalkenyl], heterocycloaliphatic [e.g., heterocycloalkyl or heterocycloalkenyl], aryl, heteroaryl, alkoxy, aroyl, heteroaroyl, acyl [e.g., (aliphatic)carbonyl, (cycloaliphatic)carbonyl, or (heterocycloaliphatic)carbonyl], nitro, cyano, amido [e.g., (cycloalkylalkyl)carbonylamino, arylcarbonylamino, aralkylcarbonylamino, (heterocycloalkyl)carbonylamino, (heterocycloalkylalkyl)carbonylamino, heteroarylcarbonylamino, heteroaralkylcarbonylamino alkylaminocarbonyl, cycloalkylaminocarbonyl, heterocycloalkylaminocarbonyl, arylaminocarbonyl, or heteroarylaminocarbonyl], amino [e.g., aliphaticamino, cycloaliphaticamino, or heterocycloaliphaticamino], sulfonyl [e.g., aliphatic-SO₂—], sulfinyl, sulfanyl, sulfoxy, urea, thiourea, sulfamoyl, sulfamide, oxo, carboxy, carbamoyl, cycloaliphaticoxy, heterocycloaliphaticoxy, aryloxy, heteroaryloxy, aralkyloxy, heteroarylalkoxy, alkoxycarbonyl, alkylcarbonyloxy, or hydroxy. Without limitation, some examples of substituted alkyls include carboxyalkyl (such as HOOC-alkyl, alkoxycarbonylalkyl, and alkylcarbonyloxyalkyl), cyanoalkyl, hydroxyalkyl, alkoxyalkyl, acylalkyl, aralkyl, (alkoxyaryl)alkyl, (sulfonylamino)alkyl (such as (alkyl-SO₂-amino)alkyl), aminoalkyl, amidoalkyl, (cycloaliphatic)alkyl, or haloalkyl.

As used herein, an “alkenyl” group refers to an aliphatic carbon group that contains 2-8 (e.g., 2-12, 2-6, or 2-4) carbon atoms and at least one double bond. Like an alkyl group, an alkenyl group can be straight or branched. Examples of an alkenyl group include, but are not limited to allyl, 1- or 2-isopropenyl, 2-butenyl, and 2-hexenyl. An alkenyl group can be optionally substituted with one or more substituents such as halo, phospho, cycloaliphatic [e.g., cycloalkyl or cycloalkenyl], heterocycloaliphatic [e.g., heterocycloalkyl or heterocycloalkenyl], aryl, heteroaryl, alkoxy, aroyl, heteroaroyl, acyl [e.g., (aliphatic)carbonyl, (cycloaliphatic)carbonyl, or (heterocycloaliphatic)carbonyl], nitro, cyano, amido [e.g., (cycloalkylalkyl)carbonylamino, arylcarbonylamino, aralkylcarbonylamino, (heterocycloalkyl)carbonylamino, (heterocycloalkylalkyl)carbonylamino, heteroarylcarbonylamino, heteroaralkylcarbonylamino alkylaminocarbonyl, cycloalkylaminocarbonyl, heterocycloalkylaminocarbonyl, arylaminocarbonyl, or heteroarylaminocarbonyl], amino [e.g., aliphaticamino, cycloaliphaticamino, heterocycloaliphaticamino, or aliphaticsulfonylamino], sulfonyl [e.g., alkyl-SO₂—, cycloaliphatic-SO₂—, or aryl-SO₂—], sulfinyl, sulfanyl, sulfoxy, urea, thiourea, sulfamoyl, sulfamide, oxo, carboxy, carbamoyl, cycloaliphaticoxy, heterocycloaliphaticoxy, aryloxy, heteroaryloxy, aralkyloxy, heteroaralkoxy, alkoxycarbonyl, alkylcarbonyloxy, or hydroxy.

Without limitation, some examples of substituted alkenyls include cyanoalkenyl, alkoxyalkenyl, acylalkenyl, hydroxyalkenyl, aralkenyl, (alkoxyaryl)alkenyl, (sulfonylamino)alkenyl (such as (alkyl-SO₂-amino)alkenyl), aminoalkenyl, amidoalkenyl, (cycloaliphatic)alkenyl, or haloalkenyl.

As used herein, an “alkynyl” group refers to an aliphatic carbon group that contains 2-8 (e.g., 2-12, 2-6, or 2-4) carbon atoms and has at least one triple bond. An alkynyl group can be straight or branched. Examples of an alkynyl group include, but are not limited to, propargyl and butynyl. An alkynyl group can be optionally substituted with one or more substituents such as aroyl, heteroaroyl, alkoxy, cycloalkyloxy, heterocycloalkyloxy, aryloxy, heteroaryloxy, aralkyloxy, nitro, carboxy, cyano, halo, hydroxy, sulfo, mercapto, sulfanyl [e.g., aliphaticsulfanyl or cycloaliphaticsulfanyl], sulfinyl [e.g., aliphaticsulfinyl or cycloaliphaticsulfinyl], sulfonyl [e.g., aliphatic-SO₂—, aliphaticamino-SO₂—, or cycloaliphatic-SO₂—], amido [e.g., aminocarbonyl, alkylaminocarbonyl, alkylcarbonylamino, cycloalkylaminocarbonyl, heterocycloalkylaminocarbonyl, cycloalkylcarbonylamino, arylaminocarbonyl, arylcarbonylamino, aralkylcarbonylamino, (heterocycloalkyl)carbonylamino, (cycloalkylalkyl)carbonylamino, heteroaralkylcarbonylamino, heteroarylcarbonylamino or heteroarylaminocarbonyl], urea, thiourea, sulfamoyl, sulfamide, alkoxycarbonyl, alkylcarbonyloxy, cycloaliphatic, heterocycloaliphatic, aryl, heteroaryl, acyl [e.g., (cycloaliphatic)carbonyl or (heterocycloaliphatic)carbonyl], amino [e.g., aliphaticamino], sulfoxy, oxo, carboxy, carbamoyl, (cycloaliphatic)oxy, (heterocycloaliphatic)oxy, or (heteroaryl)alkoxy.

As used herein, an “amido” encompasses both “aminocarbonyl” and “carbonylamino.” These terms when used alone or in connection with another group refer to an amido group such as —N(R^{X})—C(O)—R^{Y} or —C(O)—N(R^{X})₂, when used terminally, and —C(O)—N(R^{X})— or —N(R^{X})—C(O)— when used internally, wherein R^{X} and R^{Y} can be aliphatic, cycloaliphatic, aryl, araliphatic, heterocycloaliphatic, heteroaryl or heteroaraliphatic. Examples of amido groups include alkylamido (such as alkylcarbonylamino or alkylaminocarbonyl), (heterocycloaliphatic)amido, (heteroaralkyl)amido, (heteroaryl)amido, (heterocycloalkyl)alkylamido, arylamido, aralkylamido, (cycloalkyl)alkylamido, or cycloalkylamido.

As used herein, an “amino” group refers to —NR^{X}R^{Y} wherein each of R^{X} and R^{Y} is independently hydrogen, aliphatic, cycloaliphatic, (cycloaliphatic)aliphatic, aryl, araliphatic, heterocycloaliphatic, (heterocycloaliphatic)aliphatic, heteroaryl, carboxy, sulfanyl, sulfinyl, sulfonyl, (aliphatic)carbonyl, (cycloaliphatic)carbonyl, ((cycloaliphatic)aliphatic)carbonyl, arylcarbonyl, (araliphatic)carbonyl, (heterocycloaliphatic)carbonyl, ((heterocycloaliphatic)aliphatic)carbonyl, (heteroaryl)carbonyl, or (heteroaraliphatic)carbonyl, each of which being defined herein and being optionally substituted. Examples of amino groups include alkylamino, dialkylamino, or arylamino. When the term “amino” is not the terminal group (e.g., alkylcarbonylamino), it is represented by —NR^{X}—, where R^{X} has the same meaning as defined above.

As used herein, an “aryl” group used alone or as part of a larger moiety as in “aralkyl,” “aralkoxy,” or “aryloxyalkyl” refers to monocyclic (e.g., phenyl); bicyclic (e.g., indenyl, naphthalenyl, tetrahydronaphthyl, tetrahydroindenyl); and tricyclic (e.g., fluorenyl tetrahydrofluorenyl, or tetrahydroanthracenyl, anthracenyl) ring systems in which the monocyclic ring system is aromatic or at least one of the rings in a bicyclic or tricyclic ring system is aromatic. The bicyclic and tricyclic groups include benzofused 2-3 membered carbocyclic rings. For example, a benzofused group includes phenyl fused with two or more C₄₋₈ carbocyclic moieties. An aryl is optionally substituted with one or more substituents including aliphatic [e.g., alkyl, alkenyl, or alkynyl]; cycloaliphatic; (cycloaliphatic)aliphatic; heterocycloaliphatic; (heterocycloaliphatic)aliphatic; aryl; heteroaryl; alkoxy; (cycloaliphatic)oxy; (heterocycloaliphatic)oxy; aryloxy; heteroaryloxy; (araliphatic)oxy; (heteroaraliphatic)oxy; aroyl; heteroaroyl; amino; oxo (on a non-aromatic carbocyclic ring of a benzofused bicyclic or tricyclic aryl); nitro; carboxy; amido; acyl [e.g., (aliphatic)carbonyl; (cycloaliphatic)carbonyl; ((cycloaliphatic)aliphatic)carbonyl; (araliphatic)carbonyl; (heterocycloaliphatic)carbonyl; ((heterocycloaliphatic)aliphatic)carbonyl; or (heteroaraliphatic)carbonyl]; sulfonyl [e.g., aliphatic-SO₂— or amino-SO₂—]; sulfinyl [e.g., aliphatic-S(O)— or cycloaliphatic-S(O)—]; sulfanyl [e.g., aliphatic-S—]; cyano; halo; hydroxy; mercapto; sulfoxy; urea; thiourea; sulfamoyl; sulfamide; or carbamoyl. Alternatively, an aryl can be unsubstituted.

Non-limiting examples of substituted aryls include haloaryl [e.g., mono-, di (such as p,m-dihaloaryl), and (trihalo)aryl]; (carboxy)aryl [e.g., (alkoxycarbonyl)aryl, ((aralkyl)carbonyloxy)aryl, and (alkoxycarbonyl)aryl]; (amido)aryl [e.g., (aminocarbonyl)aryl, (((alkylamino)alkyl)aminocarbonyl)aryl, (alkylcarbonyl)aminoaryl, (arylaminocarbonyl)aryl, and (((heteroaryl)amino)carbonyl)aryl]; aminoaryl [e.g., ((alkylsulfonyl)amino)aryl or ((dialkyl)amino)aryl]; (cyanoalkyl)aryl; (alkoxy)aryl; (sulfamoyl)aryl [e.g., (aminosulfonyl)aryl]; (alkylsulfonyl)aryl; (cyano)aryl; (hydroxyalkyl)aryl; ((alkoxy)alkyl)aryl; (hydroxy)aryl, ((carboxy)alkyl)aryl; (((dialkyl)amino)alkyl)aryl; (nitroalkyl)aryl; (((alkylsulfonyl)amino)alkyl)aryl; ((heterocycloaliphatic)carbonyl)aryl; ((alkylsulfonyl)alkyl)aryl; (cyanoalkyl)aryl; (hydroxyalkyl)aryl; (alkylcarbonyl)aryl; alkylaryl; (trihaloalkyl)aryl; p-amino-m-alkoxycarbonylaryl; p-amino-m-cyanoaryl; p-halo-m-aminoaryl; or (m-(heterocycloaliphatic)-o-(alkyl))aryl.

As used herein, an “araliphatic” such as an “aralkyl” group refers to an aliphatic group (e.g., a C₁₋₄ alkyl group) that is substituted with an aryl group. “Aliphatic,” “alkyl,” and “aryl” are defined herein. An example of an araliphatic such as an aralkyl group is benzyl.

As used herein, an “aralkyl” group refers to an alkyl group (e.g., a C₁₋₄ alkyl group) that is substituted with an aryl group. Both “alkyl” and “aryl” have been defined above. An example of an aralkyl group is benzyl. An aralkyl is optionally substituted with one or more substituents such as aliphatic [e.g., alkyl, alkenyl, or alkynyl, including carboxyalkyl, hydroxyalkyl, or haloalkyl such as trifluoromethyl], cycloaliphatic [e.g., cycloalkyl or cycloalkenyl], (cycloalkyl)alkyl, heterocycloalkyl, (heterocycloalkyl)alkyl, aryl, heteroaryl, alkoxy, cycloalkyloxy, heterocycloalkyloxy, aryloxy, heteroaryloxy, aralkyloxy, heteroaralkyloxy, aroyl, heteroaroyl, nitro, carboxy, alkoxycarbonyl, alkylcarbonyloxy, amido [e.g., aminocarbonyl, alkylcarbonylamino, cycloalkylcarbonylamino, (cycloalkylalkyl)carbonylamino, arylcarbonylamino, aralkylcarbonylamino, (heterocycloalkyl)carbonylamino, (heterocycloalkylalkyl)carbonylamino, heteroarylcarbonylamino, or heteroaralkylcarbonylamino], cyano, halo, hydroxy, acyl, mercapto, alkylsulfanyl, sulfoxy, urea, thiourea, sulfamoyl, sulfamide, oxo, or carbamoyl.

As used herein, a “bicyclic ring system” includes 6-12 (e.g., 8-12 or 9, 10, or 11) membered structures that form two rings, wherein the two rings have at least one atom in common (e.g., 2 atoms in common). Bicyclic ring systems include bicycloaliphatics (e.g., bicycloalkyl or bicycloalkenyl), bicycloheteroaliphatics, bicyclic aryls, and bicyclic heteroaryls.

As used herein, a “cycloaliphatic” group encompasses a “cycloalkyl” group and a “cycloalkenyl” group, each of which being optionally substituted as set forth below.

As used herein, a “cycloalkyl” group refers to a saturated carbocyclic mono- or bicyclic (fused or bridged) ring of 3-10 (e.g., 5-10) carbon atoms. Examples of cycloalkyl groups include cyclopropyl, cyclobutyl, cyclopentyl, cyclohexyl, cycloheptyl, adamantyl, norbornyl, cubyl, octahydro-indenyl, decahydro-naphthyl, bicyclo[3.2.1]octyl, bicyclo[2.2.2]octyl, bicyclo[3.3.1]nonyl, bicyclo[3.3.2.]decyl, bicyclo[2.2.2]octyl, adamantyl, or ((aminocarbonyl)cycloalkyl)cycloalkyl.

A “cycloalkenyl” group, as used herein, refers to a non-aromatic carbocyclic ring of 3-10 (e.g., 4-8) carbon atoms having one or more double bonds. Examples of cycloalkenyl groups include cyclopentenyl, 1,4-cyclohexa-di-enyl, cycloheptenyl, cyclooctenyl, hexahydro-indenyl, octahydro-naphthyl, cyclohexenyl, bicyclo[2.2.2]octenyl, or bicyclo[3.3.1]nonenyl.

A cycloalkyl or cycloalkenyl group can be optionally substituted with one or more substituents such as phospho, aliphatic [e.g., alkyl, alkenyl, or alkynyl], cycloaliphatic, (cycloaliphatic) aliphatic, heterocycloaliphatic, (heterocycloaliphatic) aliphatic, aryl, heteroaryl, alkoxy, (cycloaliphatic)oxy, (heterocycloaliphatic)oxy, aryloxy, heteroaryloxy, (araliphatic)oxy, (heteroaraliphatic)oxy, aroyl, heteroaroyl, amino, amido [e.g., (aliphatic)carbonylamino, (cycloaliphatic)carbonylamino, ((cycloaliphatic)aliphatic)carbonylamino, (aryl)carbonylamino, (araliphatic)carbonylamino, (heterocycloaliphatic)carbonylamino, ((heterocycloaliphatic)aliphatic)carbonylamino, (heteroaryl)carbonylamino, or (heteroaraliphatic)carbonylamino], nitro, carboxy [e.g., HOOC—, alkoxycarbonyl, or alkylcarbonyloxy], acyl [e.g., (cycloaliphatic)carbonyl, ((cycloaliphatic) aliphatic)carbonyl, (araliphatic)carbonyl, (heterocycloaliphatic)carbonyl, ((heterocycloaliphatic)aliphatic)carbonyl, or (heteroaraliphatic)carbonyl], cyano, halo, hydroxy, mercapto, sulfonyl [e.g., alkyl-SO₂— and aryl-SO₂—], sulfinyl [e.g., alkyl-S(O)—], sulfanyl [e.g., alkyl-S—], sulfoxy, urea, thiourea, sulfamoyl, sulfamide, oxo, or carbamoyl.

As used herein, the term “heterocycloaliphatic” encompasses heterocycloalkyl groups and heterocycloalkenyl groups, each of which being optionally substituted as set forth below.

As used herein, a “heterocycloalkyl” group refers to a 3-10 membered mono- or bicylic (fused or bridged) (e.g., 5- to 10-membered mono- or bicyclic) saturated ring structure, in which one or more of the ring atoms is a heteroatom (e.g., N, O, S, or combinations thereof). Examples of a heterocycloalkyl group include piperidyl, piperazyl, tetrahydropyranyl, tetrahydrofuryl,

1,4-dioxolanyl, 1,4-dithianyl, 1,3-dioxolanyl, oxazolidyl, isoxazolidyl, morpholinyl, thiomorpholyl, octahydrobenzofuryl, octahydrochromenyl, octahydrothiochromenyl, octahydroindolyl, octahydropyrindinyl, decahydroquinolinyl, octahydrobenzo[b]thiopheneyl, 2-oxa-bicyclo[2.2.2]octyl, 1-aza-bicyclo[2.2.2]octyl, 3-aza-bicyclo[3.2.1]octyl, and 2,6-dioxa-tricyclo[3.3.1.0^{3,7}]nonyl. A monocyclic heterocycloalkyl group can be fused with a phenyl moiety to form structures, such as tetrahydroisoquinoline, that would be categorized as heteroaryls.

A “heterocycloalkenyl” group, as used herein, refers to a mono- or bicylic (e.g., 5- to 10-membered mono- or bicyclic) non-aromatic ring structure having one or more double bonds, and wherein one or more of the ring atoms is a heteroatom (e.g., N, O, or S). Monocyclic and bicyclic heterocycloaliphatics are numbered according to standard chemical nomenclature.

A heterocycloalkyl or heterocycloalkenyl group can be optionally substituted with one or more substituents such as phospho, aliphatic [e.g., alkyl, alkenyl, or alkynyl], cycloaliphatic, (cycloaliphatic)aliphatic, heterocycloaliphatic, (heterocycloaliphatic)aliphatic, aryl, heteroaryl, alkoxy, (cycloaliphatic)oxy, (heterocycloaliphatic)oxy, aryloxy, heteroaryloxy, (araliphatic)oxy, (heteroaraliphatic)oxy, aroyl, heteroaroyl, amino, amido [e.g., (aliphatic)carbonylamino, (cycloaliphatic)carbonylamino, ((cycloaliphatic) aliphatic)carbonylamino, (aryl)carbonylamino, (araliphatic)carbonylamino, (heterocycloaliphatic)carbonylamino, ((heterocycloaliphatic) aliphatic)carbonylamino, (heteroaryl)carbonylamino, or (heteroaraliphatic)carbonylamino], nitro, carboxy [e.g., HOOC—, alkoxycarbonyl, or alkylcarbonyloxy], acyl [e.g., (cycloaliphatic)carbonyl, ((cycloaliphatic) aliphatic)carbonyl, (araliphatic)carbonyl, (heterocycloaliphatic)carbonyl, ((heterocycloaliphatic)aliphatic)carbonyl, or (heteroaraliphatic)carbonyl], nitro, cyano, halo, hydroxy, mercapto, sulfonyl [e.g., alkylsulfonyl or arylsulfonyl], sulfinyl [e.g., alkylsulfinyl], sulfanyl [e.g., alkylsulfanyl], sulfoxy, urea, thiourea, sulfamoyl, sulfamide, oxo, or carbamoyl.

A “heteroaryl” group, as used herein, refers to a monocyclic, bicyclic, or tricyclic ring system having 4 to 15 ring atoms wherein one or more of the ring atoms is a heteroatom (e.g., N, O, S, or combinations thereof) and in which the monocyclic ring system is aromatic or at least one of the rings in the bicyclic or tricyclic ring systems is aromatic. A heteroaryl group includes a benzofused ring system having 2 to 3 rings. For example, a benzofused group includes benzo fused with one or two 4 to 8 membered heterocycloaliphatic moieties (e.g., indolizyl, indolyl, isoindolyl, 3H-indolyl, indolinyl, benzo[b]furyl, benzo[b]thiophene-yl, quinolinyl, or isoquinolinyl). Some examples of heteroaryl are azetidinyl, pyridyl, 1H-indazolyl, furyl, pyrrolyl, thienyl, thiazolyl, oxazolyl, imidazolyl, tetrazolyl, benzofuryl, isoquinolinyl, benzthiazolyl, xanthene, thioxanthene, phenothiazine, dihydroindole, benzo[1,3]dioxole, benzo[b]furyl, benzo[b]thiophenyl, indazolyl, benzimidazolyl, benzthiazolyl, puryl, cinnolyl, quinolyl, quinazolyl, cinnolyl, phthalazyl, quinazolyl, quinoxalyl, isoquinolyl, 4H-quinolizyl, benzo-1,2,5-thiadiazolyl, or 1,8-naphthyridyl.

Without limitation, monocyclic heteroaryls include furyl, thiophene-yl, 2H-pyrrolyl, pyrrolyl, oxazolyl, thazolyl, imidazolyl, pyrazolyl, isoxazolyl, isothiazolyl, 1,3,4-thiadiazolyl, 2H-pyranyl, 4-H-pranyl, pyridyl, pyridazyl, pyrimidyl, pyrazolyl, pyrazyl, or 1,3,5-triazyl. Monocyclic heteroaryls are numbered according to standard chemical nomenclature.

Without limitation, bicyclic heteroaryls include indolizyl, indolyl, isoindolyl, 3H-indolyl, indolinyl, benzo[b]furyl, benzo[b]thiophenyl, quinolinyl, isoquinolinyl, indolizyl, isoindolyl, indolyl, benzo[b]furyl, bexo[b]thiophenyl, indazolyl, benzimidazyl, benzthiazolyl, purinyl, 4H-quinolizyl, quinolyl, isoquinolyl, cinnolyl, phthalazyl, quinazolyl, quinoxalyl, 1,8-naphthyridyl, or pteridyl. Bicyclic heteroaryls are numbered according to standard chemical nomenclature.

A heteroaryl is optionally substituted with one or more substituents such as aliphatic [e.g., alkyl, alkenyl, or alkynyl]; cycloaliphatic; (cycloaliphatic)aliphatic; heterocycloaliphatic; (heterocycloaliphatic)aliphatic; aryl; heteroaryl; alkoxy; (cycloaliphatic)oxy; (heterocycloaliphatic)oxy; aryloxy; heteroaryloxy; (araliphatic)oxy; (heteroaraliphatic)oxy; aroyl; heteroaroyl; amino; oxo (on a non-aromatic carbocyclic or heterocyclic ring of a bicyclic or tricyclic heteroaryl); carboxy; amido; acyl [e.g., aliphaticcarbonyl; (cycloaliphatic)carbonyl; ((cycloaliphatic)aliphatic)carbonyl; (araliphatic)carbonyl; (heterocycloaliphatic)carbonyl; ((heterocycloaliphatic)aliphatic)carbonyl; or (heteroaraliphatic)carbonyl]; sulfonyl [e.g., aliphaticsulfonyl or aminosulfonyl]; sulfinyl [e.g., aliphaticsulfinyl]; sulfanyl [e.g., aliphaticsulfanyl]; nitro; cyano; halo; hydroxy; mercapto; sulfoxy; urea; thiourea; sulfamoyl; sulfamide; or carbamoyl. Alternatively, a heteroaryl can be unsubstituted.

Non-limiting examples of substituted heteroaryls include (halo)heteroaryl [e.g., mono- and di-(halo)heteroaryl]; (carboxy)heteroaryl [e.g., (alkoxycarbonyl)heteroaryl]; cyanoheteroaryl; aminoheteroaryl [e.g., ((alkylsulfonyl)amino)heteroaryl and ((dialkyl)amino)heteroaryl]; (amido)heteroaryl [e.g., aminocarbonylheteroaryl, ((alkylcarbonyl)amino)heteroaryl, ((((alkyl)amino)alkyl)aminocarbonyl)heteroaryl, (((heteroaryl)amino)carbonyl)heteroaryl, ((heterocycloaliphatic)carbonyl)heteroaryl, and ((alkylcarbonyl)amino)heteroaryl]; (cyanoalkyl)heteroaryl; (alkoxy)heteroaryl; (sulfamoyl)heteroaryl [e.g., (aminosulfonyl)heteroaryl]; (sulfonyl)heteroaryl [e.g., (alkylsulfonyl)heteroaryl]; (hydroxyalkyl)heteroaryl; (alkoxyalkyl)heteroaryl; (hydroxy)heteroaryl; ((carboxy)alkyl)heteroaryl; (((dialkyl)amino)alkyl]heteroaryl; (heterocycloaliphatic)heteroaryl; (cycloaliphatic)heteroaryl; (nitroalkyl)heteroaryl; (((alkylsulfonyl)amino)alkyl)heteroaryl; ((alkylsulfonyl)alkyl)heteroaryl; (cyanoalkyl)heteroaryl; (acyl)heteroaryl [e.g., (alkylcarbonyl)heteroaryl]; (alkyl)heteroaryl; or (haloalkyl)heteroaryl [e.g., trihaloalkylheteroaryl].

As used herein, a “heteroaraliphatic” (such as a heteroaralkyl group) refers to an aliphatic group (e.g., a C₁₋₄ alkyl group) that is substituted with a heteroaryl group. “Aliphatic,” “alkyl,” and “heteroaryl” have been defined above.

As used herein, a “heteroaralkyl” group refers to an alkyl group (e.g., a C₁₋₄ alkyl group) that is substituted with a heteroaryl group. Both “alkyl” and “heteroaryl” have been defined above. A heteroaralkyl is optionally substituted with one or more substituents such as alkyl (including carboxyalkyl, hydroxyalkyl, and haloalkyl such as trifluoromethyl), alkenyl, alkynyl, cycloalkyl, (cycloalkyl)alkyl, heterocycloalkyl, (heterocycloalkyl)alkyl, aryl, heteroaryl, alkoxy, cycloalkyloxy, heterocycloalkyloxy, aryloxy, heteroaryloxy, aralkyloxy, heteroaralkyloxy, aroyl, heteroaroyl, nitro, carboxy, alkoxycarbonyl, alkylcarbonyloxy, aminocarbonyl, alkylcarbonylamino, cycloalkylcarbonylamino, (cycloalkylalkyl)carbonylamino, arylcarbonylamino, aralkylcarbonylamino, (heterocycloalkyl)carbonylamino, (heterocycloalkylalkyl)carbonylamino, heteroarylcarbonylamino, heteroaralkylcarbonylamino, cyano, halo, hydroxy, acyl, mercapto, alkylsulfanyl, sulfoxy, urea, thiourea, sulfamoyl, sulfamide, oxo, or carbamoyl.

As used herein, “cyclic moiety” and “cyclic group” refer to mono-, bi-, and tri-cyclic ring systems including cycloaliphatic, heterocycloaliphatic, aryl, or heteroaryl, each of which has been previously defined.

As used herein, a “bridged bicyclic ring system” refers to a bicyclic heterocyclicalipahtic ring system or bicyclic cycloaliphatic ring system in which the rings are bridged. Examples of bridged bicyclic ring systems include, but are not limited to, adamantanyl, norbornanyl, bicyclo[3.2.1]octyl, bicyclo[2.2.2]octyl, bicyclo[3.3.1]nonyl, bicyclo[3.3.2]decyl, 2-oxabicyclo[2.2.2]octyl, 1-azabicyclo[2.2.2]octyl, 3-azabicyclo[3.2.1]octyl, and 2,6-dioxa-tricyclo[3.3.1.0^{3,7}]nonyl. A bridged bicyclic ring system can be optionally substituted with one or more substituents such as alkyl (including carboxyalkyl, hydroxyalkyl, and haloalkyl such as trifluoromethyl), alkenyl, alkynyl, cycloalkyl, (cycloalkyl)alkyl, heterocycloalkyl, (heterocycloalkyl)alkyl, aryl, heteroaryl, alkoxy, cycloalkyloxy, heterocycloalkyloxy, aryloxy, heteroaryloxy, aralkyloxy, heteroaralkyloxy, aroyl, heteroaroyl, nitro, carboxy, alkoxycarbonyl, alkylcarbonyloxy, aminocarbonyl, alkylcarbonylamino, cycloalkylcarbonylamino, (cycloalkylalkyl)carbonylamino, arylcarbonylamino, aralkylcarbonylamino, (heterocycloalkyl)carbonylamino, (heterocycloalkylalkyl)carbonylamino, heteroarylcarbonylamino, heteroaralkylcarbonylamino, cyano, halo, hydroxy, acyl, mercapto, alkylsulfanyl, sulfoxy, urea, thiourea, sulfamoyl, sulfamide, oxo, or carbamoyl.

As used herein, an “acyl” group refers to a formyl group or R^{X}—C(O)— (such as alkyl-C(O)—, also referred to as “alkylcarbonyl”) where R^{X} and “alkyl” have been defined previously. Acetyl and pivaloyl are examples of acyl groups.

As used herein, an “aroyl” or “heteroaroyl” refers to an aryl-C(O)— or a heteroaryl-C(O)—. The aryl and heteroaryl portion of the aroyl or heteroaroyl is optionally substituted as previously defined.

As used herein, an “alkoxy” group refers to an alkyl-O— group where “alkyl” has been defined previously.

As used herein, a “carbamoyl” group refers to a group having the structure —O—CO—NR^{X}R^{Y} or —NR^{X}—CO—O—R^{Z}, wherein R^{X} and R^{Y} have been defined above and R^{Z} can be aliphatic, aryl, araliphatic, heterocycloaliphatic, heteroaryl, or heteroaraliphatic.

As used herein, a “carboxy” group refers to —COOH, —COOR^{X}, —OC(O)H, —OC(O)R^{X}, when used as a terminal group; or —OC(O)— or —C(O)O— when used as an internal group.

As used herein, a “haloaliphatic” group refers to an aliphatic group substituted with 1-3 halogen. For instance, the term haloalkyl includes the group —CF₃.

As used herein, a “mercapto” group refers to —SH.

As used herein, a “sulfo” group refers to —SO₃H or —SO₃R^{X} when used terminally or —S(O)₃— when used internally.

As used herein, a “sulfamide” group refers to the structure —NR^{X}—S(O)₂—NR^{Y}R^{Z} when used terminally and —NR^{X}—S(O)₂—NR^{Y}— when used internally, wherein R^{X}, R^{Y}, and R^{Z} have been defined above.

As used herein, a “sulfamoyl” group refers to the structure —O—S(O)₂—NR^{Y}R^{Z} wherein R^{Y} and R^{Z} have been defined above.

As used herein, a “sulfonamide” group refers to the structure —S(O)₂—NR^{X}R^{Y} or —NR^{X}—S(O)₂—R^{Z} when used terminally; or —S(O)₂—NR^{X}— or —NR^{X}—S(O)₂— when used internally, wherein R^{X}, R^{Y}, and R^{Z} are defined above.

As used herein a “sulfanyl” group refers to —S—R^{X} when used terminally and —S— when used internally, wherein R^{X} has been defined above. Examples of sulfanyls include aliphatic-S—, cycloaliphatic-S—, aryl-S—, or the like.

As used herein a “sulfinyl” group refers to —S(O)—R^{X} when used terminally and —S(O)— when used internally, wherein R^{X} has been defined above. Examples of sulfinyl groups include aliphatic-S(O)—, aryl-S(O)—, (cycloaliphatic(aliphatic))-S(O)—, cycloalkyl-S(O)—, heterocycloaliphatic-S(O)—, heteroaryl-S(O)—, or the like.

As used herein, a “sulfonyl” group refers to —S(O)₂—R^{X} when used terminally and —S(O)₂— when used internally, wherein R^{X} has been defined above. Examples of sulfonyl groups include aliphatic-S(O)₂—, aryl-S(O)₂—, (cycloaliphatic(aliphatic))-S(O)₂—, cycloaliphatic-S(O)₂—, heterocycloaliphatic-S(O)₂—, heteroaryl-S(O)₂—, (cycloaliphatic(amido(aliphatic)))-S(O)₂— or the like.

As used herein, a “sulfoxy” group refers to —O—S(O)—R^{X} or —S(O)—O—R^{X}, when used terminally and —O—S(O)— or —S(O)—O— when used internally, where R^{X} has been defined above.

As used herein, a “halogen” or “halo” group refers to fluorine, chlorine, bromine or iodine.

As used herein, an “alkoxycarbonyl,” which is encompassed by the term carboxy, used alone or in connection with another group refers to a group such as alkyl-O—C(O)—.

As used herein, an “alkoxyalkyl” refers to an alkyl group such as alkyl-O-alkyl-, wherein alkyl has been defined above.

As used herein, a “carbonyl” refers to —C(O)—.

As used herein, an “oxo” refers to =0.

As used herein, the term “phospho” refers to phosphinates and phosphonates. Examples of phosphinates and phosphonates include —P(O)(R^{P})₂, wherein R^{P} is aliphatic, alkoxy, aryloxy, heteroaryloxy, (cycloaliphatic)oxy, (heterocycloaliphatic)oxy aryl, heteroaryl, cycloaliphatic or amino.

As used herein, an “aminoalkyl” refers to the structure (R^{X})₂N-alkyl-.

As used herein, a “cyanoalkyl” refers to the structure (NC)-alkyl-.

As used herein, a “urea” group refers to the structure —NR^{X}—CO—NR^{Y}R^{Z} and a “thiourea” group refers to the structure —NR^{X}—CS—NR^{Y}R^{Z} when used terminally and —NR^{X}—CO—NR^{Y}— or —NR^{X}—CS—NR^{Y}— when used internally, wherein R^{X}, R^{Y}, and R^{Z} have been defined above.

As used herein, a “guanidine” group refers to the structure —N═C(N(R^{X}R^{Y}))N(R^{X}R^{Y}) or —NR^{X}—C(═NR^{X})NR^{X}R^{Y} wherein R^{X} and R^{Y} have been defined above.

As used herein, the term “amidino” group refers to the structure —C═(NR^{X})N(R^{X}R^{Y}) wherein R^{X} and R have been defined above.

As used herein, the term “vicinal” generally refers to the placement of substituents on a group that includes two or more carbon atoms, wherein the substituents are attached to adjacent carbon atoms.

As used herein, the term “geminal” generally refers to the placement of substituents on a group that includes two or more carbon atoms, wherein the substituents are attached to the same carbon atom.

The terms “terminally” and “internally” refer to the location of a group within a substituent. A group is terminal when the group is present at the end of the substituent not further bonded to the rest of the chemical structure. Carboxyalkyl, i.e., R^{X}O(O)C-alkyl, is an example of a carboxy group used terminally. A group is internal when the group is present in the middle of a substituent of the chemical structure. Alkylcarboxy (e.g., alkyl-C(O)O— or alkyl-OC(O)—) and alkylcarboxyaryl (e.g., alkyl-C(O)O-aryl- or alkyl-O(CO)-aryl-) are examples of carboxy groups used internally.

As used herein, an “aliphatic chain” refers to a branched or straight aliphatic group (e.g., alkyl groups, alkenyl groups, or alkynyl groups). A straight aliphatic chain has the structure —[CH₂]_{c}—, where v is 1-12. A branched aliphatic chain is a straight aliphatic chain that is substituted with one or more aliphatic groups. A branched aliphatic chain has the structure —[CQQ]ᵥ- where Q is independently a hydrogen or an aliphatic group; however, Q shall be an aliphatic group in at least one instance. The term aliphatic chain includes alkyl chains, alkenyl chains, and alkynyl chains, where alkyl, alkenyl, and alkynyl are defined above.

The phrase “optionally substituted” is used herein interchangeably with the phrase “substituted or unsubstituted.”

As used herein, the term “substituted,” whether preceded by the term “optionally” or not, refers generally to the replacement of hydrogen atoms in a given structure with the radical of a specified substituent. Specific substituents are described above in the definitions and below in the description of compounds and examples thereof. Unless otherwise indicated, an optionally substituted group can have a substituent at each substitutable position of the group, and when more than one position in any given structure can be substituted with more than one substituent selected from a specified group, the substituent can be either the same or different at every position. A ring substituent, such as a heterocycloalkyl, can be bound to another ring, such as a cycloalkyl, to form a spiro-bicyclic ring system, e.g., both rings share one common atom. As one of ordinary skill in the art will recognize, combinations of substituents envisioned by this invention are those combinations that result in the formation of stable or chemically feasible compounds.

### II. SYSTEMS FOR EXTRACTING WATER FROM AN AQUEOUS SOLUTION

In one aspect, the present invention provides a system for extracting water from an aqueous solution.

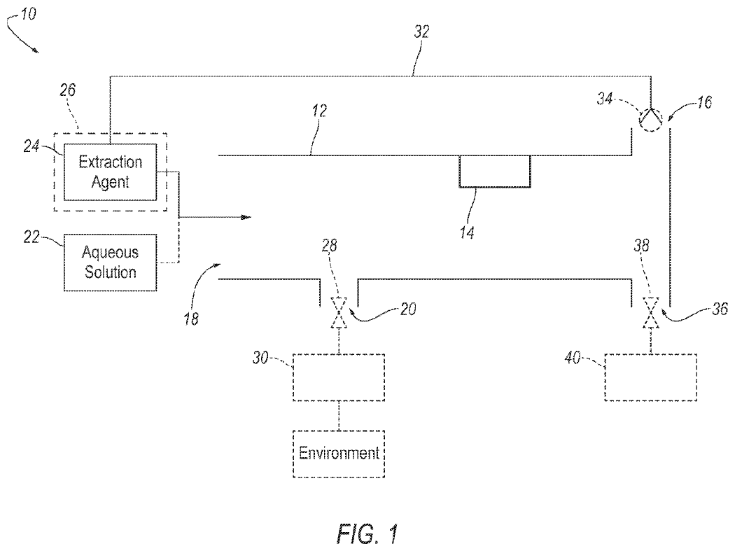

Referring to FIG. 1, in one embodiment, the system 10 for extracting water from an aqueous solution (e.g., sea water, well water, brine, brackish water, or the like) comprises a reservoir 12, a heater 14, and an upper outlet 16.

The reservoir comprises an inlet 18 and a lower outlet 20. The inlet is configured to provide a feed stream comprising an extraction agent and an aqueous solution to the reservoir under mixing conditions, at about ambient temperature (i.e., without heating or cooling the feed stream), to form a wet extraction agent phase and a raffinate phase.

The aqueous solution and the extraction agent can be mixed or combined upstream of the inlet, at the inlet, or both, using any suitable method(s) known in the art. In some embodiments, the aqueous solution is withdrawn (e.g., pumped) from an aqueous solution source 22 and combined (or mixed) with the extraction agent withdrawn from an extraction agent source 24, to form the feed stream upstream of or at the inlet of the reservoir. In other embodiments, the extraction agent source is upstream of inlet 18 and comprises a semi-permeable membrane 26 (such as any semi-permeable membrane described herein), and at least a portion of aqueous solution at the aqueous solution source passes through the semi-permeable membrane to mix with the extraction agent within the extraction agent source and to form the feed stream within the extraction agent source.

In some embodiments, the feed stream provided to the reservoir via the inlet may optionally undergo additional mixing within the reservoir. For example, in some embodiments, the reservoir comprises an optional mixer (e.g., rotor or shaker) configured to mix the aqueous solution and extraction agent forming the feed stream. The feed stream provided to the reservoir forms a wet extraction phase and a raffinate phase within the reservoir, wherein the raffinate phase has a reduced water content and an increased concentration of sodium chloride as compared to the aqueous solution at the aqueous solution source due to water absorption by the extraction agent during mixing. In some embodiments, the raffinate phase has a greater density than the wet extraction agent phase during operating conditions (e.g., operating temperatures and pressures) of the system.

With continued reference to FIG. 1, the lower outlet is reversibly closable and is configured to permit at least a portion (e.g., from about 50% to 100% by volume, from about 70% to 100% by volume, from about 80% to 100% by volume, from about 85% to 100% by volume, from about 90% to 100% by volume, from about 95% to 100% by volume, or from about 99% to 100% by volume) of the raffinate phase to exit the reservoir while retaining all or nearly all (e.g., from about 50% to 100% by volume, from about 60% to 100% by volume, from about 80% to 100% by volume, from about 90% to 100% by volume, or from about 95% to 100% by volume) of the wet extraction agent phase in the reservoir.

In some embodiments, the lower outlet comprises a reversibly closable valve 28 as shown in FIG. 1. In some embodiments, the reversibly closable valve of the lower outlet comprises a solenoid configured to open the reversibly closable valve when power is supplied to the solenoid and close when power is not supplied to the solenoid. In other embodiments, the reversibly closable valve comprises a spring-operated cap, wherein the spring-operated cap is configured to assume an open position when pressure inside the reservoir reaches a threshold.

In some embodiments, the lower outlet is spatially oriented on the reservoir so that the lower outlet is below the upper outlet, as shown in FIG. 1.

In some embodiments, as shown in FIG. 1, the system further comprises a sparging tank 30 in fluid communication with the lower outlet. When present, the sparging tank is configured to sparge at least a portion of the raffinate phase to remove at least a portion of any extraction agent present in the raffinate phase. In this manner, the raffinate phase can be released into the environment (e.g., returned to the aqueous solution source) substantially free (e.g., comprising less than 1% by volume, comprising less than 0.5% by volume, or comprising less than 0.1% by volume) or free of the extraction agent. In some embodiments, in addition to or in place of the sparging tank, the balancer comprises a granular activated carbon (GAC) filter (e.g., a bed or column).

The heater is configured to thermally communicate with the wet extraction phase and heat the wet extraction agent phase to a temperature of from about 35° C. to about 130° C. (e.g., from about 40° C. to about 110° C., from about 45° C. to about 90° C., from about 50° C. to about 85° C., or from about 60° C. to about 80° C.) to form a heated mixture comprising a dry extraction agent phase and a water phase. In some embodiments, the heater is situated within the reservoir and thermally communicates with the wet extraction agent phase. In other embodiments, the reservoir comprises a thermally conductive wall (not shown), and the heater thermally communicates with the wet extraction agent through the thermally conductive wall of the reservoir. In some embodiments, the heater comprises one or more heating elements.

The dry extraction agent phase has reduced water content compared to the wet extraction agent phase. While not being bound by theory, it is believed that heating the wet extraction agent phase decreases the water solubility of the extraction agent and causes dissolved water to desorb from the wet extraction agent phase to form the dry extraction phase and the water phase. In some embodiments, the dry extraction agent phase has a density less than the density of the water phase during operating conditions (e.g., operating temperatures and pressures) of the system.

The upper outlet fluidly communicates with a channel 32, wherein the channel is configured to permit at least a portion of the dry extraction agent phase to return to the feed stream as extraction agent. In this manner, the system allows for recycling of the extraction agent thereby reducing costs associated with the extraction process. In some embodiments, such as the embodiment shown in FIG. 1, the channel fluidly communicates with the extraction agent source, and the dry extraction agent phase flows to the extraction agent source before proceeding to the feed stream. In other embodiments, the channel does not fluidly communicate with the extraction agent source. For example, the channel fluidly communicates with a portion of the system upstream from or at the inlet. For instance, the channel may fluidly communicate with the inlet so that the dry extraction agent phase is incorporated into the feed stream at the inlet of the reservoir.

In some embodiments, the channel comprises a conduit. In some embodiments, at least a portion of the conduit comprises the semi-permeable membrane. At least a portion of the semi-permeable membrane is disposed between the aqueous solution source and extraction agent or dry extraction agent phase. For example, in some embodiments, the semi-permeable membrane is disposed between the aqueous solution source and the extraction agent source. In other embodiments, the semi-permeable membrane is disposed between the aqueous solution source and the dry extraction agent phase being recycled in the system. The semi-permeable membrane is configured to permit a portion of the aqueous solution to contact at least a portion of the extraction agent within the extraction agent source under mixing conditions to form the feed stream at the inlet of the reservoir.

In some embodiments, the semi-permeable membrane of the conduit comprises a plurality of pores. In some embodiments, the pores have a mean pore size of from about 80 nm to about 1 μm. In some embodiments, the semi-permeable membrane comprises a porosity that gives a molecular weight cut off of from about 300 D to about 3,000 D. The semi-permeable membrane may be comprised of any material suitable for facilitating contact between the aqueous solution and the extraction agent. The semi-permeable membrane may comprise, by way of non-limiting examples, a cellulose material, a polysulphone material, a polyamide material, a polyimide material, polytetrafluoroethylene (PTFE), polyvinylidene fluoride (PVDF), polyethylene oxide (PEO), polyphenylene oxide (PPO), polyvinyl chloride (PVC), chlorinated polyvinyl chloride (CPVC), polypropylene (PP), high-density polyethylene (HDPE), polyethylene (PE), or any combination thereof. In some embodiments, the semi-permeable membrane comprises a polyamide thin film composite (TFC). In other embodiments, the semi-permeable membrane comprises a cellulose acetate blend. In some embodiments, the semi-permeable membrane comprises regenerated cellulose.

Suitable semi-permeable membranes comprising a polyamide TFC are commercially available under trade names such as, for example, Filmtec™ (e.g., SeaMaxx 47 mm, SeaMaxx CFO16, SeaMaxx CF042, XC70 47 mm, XC70, CF016, and XC70 CF042) from Dupont (Wilmington, Delaware); and TRISEP® (e.g., TS80 47 mm, TS80 CF016, and TS80 CF042) from MANN+HUMMEL (Ludwigsburg, Germany). Suitable semi-permeable membranes comprising a polyamide TFC are also commercially available from Suez (Germany) (e.g., Suez AK 47 mm, Seuz AK CFO16, and Suez AK CF042). Suitable semi-permeable membranes comprising a cellulose acetate blend are commercially available under trade names such as TRISEP® (e.g., SB90 47 mm, SB90 CF016, and SB90 CF042) from MANN+HUMMEL (Ludwigsburg, Germany). Suitable semi-permeable membranes comprising regenerated cellulose are commercially available from Carolina Biological Supply (Burlington, North Carolina).

In some embodiments, the system further comprises a pump 34 that fluidly communicates with the upper outlet and the channel. In some embodiments, the pump is configured to move at least a portion of the dry extraction agent phase from the reservoir into the channel. The pump may be, by way of non-limiting example, a rotary-type positive displacement pump (such as a gear pump or a screw pump), a reciprocating-type positive displacement pump (such as a plunger pump, a diaphragm pump or a piston pump), a linear-type positive displacement pump (such as a rope pump or a chain pump), an impulse pump (such as a hydraulic ram pump, a pulser pump or an airlift pump), a velocity pump, a radial-flow pump, an axial-flow pump, or a gravity pump.

In some embodiments, the reservoir further comprises an optional second lower outlet 36. When present, the second lower outlet is configured to permit at least a portion of the water phase to exit the reservoir. In some embodiments, the second lower outlet is reversibly closable. For example, the second lower outlet comprises a second reversibly closable valve 38. The second reversibly closable valve may be any valve as described herein.

In some embodiments, the second lower outlet fluidly communicates with a tank. For example, the second lower outlet fluidly communicates with a second sparging tank 40. When present, the second sparging tank is configured to sparge at least a portion of the water phase to remove at least a portion of any extraction agent from the water phase. In other embodiments, the second lower outlet fluidly communicates with a tank that comprises a filtration (e.g., osmotic filter, GAC filter, and the like) device, a distillation device, or both, wherein the filtration device and/or the distillation device are configured to separate substantially pure water from the water phase. In these manners, water from the water phase can be recovered substantially free (e.g., comprising less than 1% by volume, comprising less than 0.5% by volume, or comprising less than 0.1% by volume) or free of the extraction agent and/or other impurities.

In some embodiments, the second sparging tank may comprise a gas outlet. The gas outlet may be in fluid communication with the channel via a sparging tank conduit. When the sparging tank conduit is present, extraction agent vaporized from the water phase in the sparging tank may travel, as a gas, through the sparging tank conduit to the channel as dry extraction agent. In some embodiments, the sparging tank conduit may further include a condenser to convert the gaseous vaporized extraction agent into liquid dry extraction agent. Moreover, the sparging tank conduit and the upper outlet may feed dry extraction agent into a surge tank in fluid communication with the channel. In this manner, any extraction agent removed from the water phase in the second sparging tank can be returned to the channel.

In some embodiments, the second lower outlet is spatially oriented on the reservoir so that the second lower outlet is below the upper outlet, as shown in FIG. 1.

In some embodiments, the second lower outlet fluidly communicates with the extraction agent source via a second channel (not shown) configured to permit at least a portion of the water phase to combine or mix with extraction agent. In some embodiments the second lower outlet fluidly communicates with the channel and is configured to mix at least a portion of the dry extraction agent phase (i.e., the recycled dry extraction agent phase) with at least a portion of the water phase to form a second feed stream comprising extraction agent and the water phase, wherein the second feed stream is provided to the reservoir at the inlet. In these manners, the system allows for the water phase to be cycled two or more times through the reservoir to further reduce the concentration of sodium chloride in the water phase. The second channel may also be configured to permit the temperature of the water phase to cool before returning to the feed stream. When the water phase is recycled through the reservoir two or more times, the second reversibly closable valve is configured to allow the water phase to be recycled to the to the inlet of the reservoir or to exit the system.

The water phase has a concentration of sodium chloride that is less than the concentration of sodium chloride in the aqueous solution. In some embodiments, the water phase has a concentration of sodium chloride that is from about 65% to about 99% less than the concentration of sodium chloride in the aqueous solution. In other embodiments, the water phase has a concentration of sodium chloride that is from about 70% to about 99% less than the concentration of sodium chloride in the aqueous solution. In some embodiments, the water phase has a concentration of sodium chloride that is from about 65% to about 95% less than the concentration of sodium chloride in the aqueous solution. And, in some embodiments, the water phase has a concentration of sodium chloride that is from about 65% to about 90% less than the concentration of sodium chloride in the aqueous solution.

In some embodiments, the water phase comprises a concentration of sodium chloride of less than about 1,500 mg/L. In some embodiments, the water phase comprises a concentration of sodium chloride of less than about 1,250 mg/L. In some embodiments, the water phase comprises a concentration of sodium chloride of less than about 1,000 mg/L. In other embodiments, the water phase comprises a concentration of sodium chloride of less than about 750 mg/L. In some embodiments, the water phase comprises a concentration of sodium chloride of less than about 500 mg/L. And, in some embodiments, the water phase comprises a concentration of sodium chloride of less than about 250 mg/L.

In some embodiments, the water phase has a concentration of total dissolved solids (TDS) of less than 15,000 mg/L. For example, the water phase has a concentration of TDS of less than 10,000 mg/L. In other embodiments, the water phase has a concentration of TDS of less than 7,500 mg/L. In some embodiments, the water phase has a concentration of TDS of less than 5,000 mg/L. In some embodiments, the water phase has a concentration of TDS of less than 2,500 mg/L. In some embodiments, the water phase has a concentration of TDS of less than 1,000 mg/L. In some embodiments, the water phase has a concentration of TDS of less than 800 mg/L. In some embodiments, the water phase has a concentration of TDS of less than 500 mg/L. In some embodiments, the water phase has a concentration of TDS of less than 250 mg/L. And, in some embodiments, the water phase has a concentration of TDS that is less than the concentration of TDS in the aqueous solution.

In some embodiments, the water phase is potable. In other embodiments, the water phase is suitable for agricultural use.

In some embodiments, the water phase is substantially free (e.g., comprising less than 1% by volume, comprising less than 0.5% by volume, or comprising less than 0.1% by volume) of the extraction agent. For example, the water phase may comprise from 0% to about 25% (e.g., from about 0.01% to about 15%, from about 0.05% to about 10%, from about 0.1% to about 8.5%, or from about 0.1% to about 5%) by volume of the extraction agent. And, in some embodiments, the water phase has no detectable amount of extraction agent.

The aqueous solution has a concentration of sodium chloride. In some embodiments, the aqueous solution has a concentration of sodium chloride of from about 300 mg/L to about 45,000 mg/L. For example, the aqueous solution has a concentration of sodium chloride of from about 30,000 mg/L to about 40,000 mg/L. In other embodiments, the aqueous solution has a sodium chloride concentration of from about 500 mg/L to about 30,000 mg/L. In some embodiments, the aqueous solution has a concentration of sodium chloride of greater than about 45,000 mg/L. In some embodiments, the aqueous solution has a concentration of sodium chloride of from about 350 mg/L to about 40,000 mg/L. In some embodiments, the aqueous solution has a concentration of sodium chloride of less than about 1,000 mg/L. In some embodiments, the aqueous solution has a concentration of sodium chloride of less than about 500 mg/L. In some embodiments, the aqueous solution has a concentration of sodium chloride of less than about 250 mg/L. In some embodiments, the aqueous solution has a concentration of sodium chloride of less than about 100 mg/L. The aqueous solution may comprise seawater; well water; brackish water; briny water; or any combination thereof. For example, the aqueous solution may be seawater or well water.

In some embodiments, the aqueous solution has a concentration of total dissolved solids (TDS) of from about 250 mg/L to about 50,000 mg/L. In some embodiments, the aqueous solution has a concentration of TDS of from about 250 mg/L to about 10,000 mg/L.

In other embodiments, the aqueous solution has a concentration of TDS of from about 1,000 mg/L to about 10,000 mg/L.

In some embodiments, the extraction agent has a density and the aqueous solution has a density, and the density of the extraction agent is less than the density of the aqueous solution. In other embodiments, the density of the extraction agent is greater than the density of the aqueous solution.

The extraction agent may comprise any extraction agent that is substantially immiscible with aqueous solutions, capable of water absorption at a first temperature (e.g., about ambient temperature), and exhibits decreased water solubility at a second temperature (e.g., about 35° C. to about 130° C.) that is higher than the first temperature. For example, in some embodiments, the extraction agent comprises a tertiary or secondary amine having the formula N(R¹)₃, wherein each R¹ is independently hydrogen, an optionally substituted straight or branched C₁₋₂₀ alkyl (e.g., C₁₋₁₂ alkyl, C₂₋₁₂ alkyl, C₁₋₁₀ alkyl, C₂₋₁₀ alkyl, C₁₋₆ alkyl, C₂₋₆ alkyl, or C₁₋₃ alkyl), an optionally substituted C₃₋₁₄ mono- or bicyclic cycloalkyl (e.g., C₃₋₈ monocyclic cycloalkyl (e.g., C₃₋₆ monocyclic alkyl) or a C₆₋₁₂ bicyclic cycloalkyl (e.g., C₆₋₁₀ bicyclic cycloalkyl)), or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In some embodiments, the extraction agent comprises a di-amine having the formula (R¹)₂N-L-N(R¹)₂ wherein L is a C₁₋₁₄ (e.g., C₁₋₁₀, C₂₋₁₀, C₁₋₈, C₂₋₈, C₁₋₆, or C₂₋₆) bivalent, straight or branched alkylene chain, and each R¹ is independently hydrogen, an optionally substituted straight or branched C₁₋₂₀ alkyl (e.g., C₁₋₁₂ alkyl, C₂₋₁₂ alkyl, C₁₋₁₀ alkyl, C₂₋₁₀ alkyl, C₁₋₆ alkyl, C₂₋₆ alkyl, or C₁₋₃ alkyl), an optionally substituted C₁₋₁₄ mono- or bicyclic cycloalkyl (e.g., C₃₋₈ monocyclic cycloalkyl (e.g., C₃₋₆ monocyclic alkyl) or a C₆₋₁₂ bicyclic cycloalkyl (e.g., C₆₋₁₀ bicyclic cycloalkyl)), or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In some embodiments, the extraction agent comprises a silamine having the formula (R²)ₙSi(NHR¹)₄₋ₙ, wherein n is 1, 2, or 3; each R¹ is independently hydrogen, a straight or branched C₁₋₁₀ alkyl, an optionally substituted C₁₋₁₀ mono- or bicyclic cycloalkyl, or an optionally substituted C₆₋₁₀ mono- or bicyclic aryl, wherein the cycloalkyl and aryl of R¹ are each optionally substituted with up to two C₁₋₄ alkyl groups; and each R² is independently hydrogen, a straight or branched C₁₋₁₀ alkyl, an optionally substituted straight or branched C₁₋₁₀ alkoxy, an optionally substituted C₁₋₁₀ mono- or bicyclic cycloalkyl, or an optionally substituted C₆₋₁₀ mono- or bicyclic aryl, wherein the cycloalkyl and aryl of R² are each optionally substituted with up to two C₁₋₄ alkyl groups, and the alkoxy of R² is optionally substituted with up to three groups independently selected from halo, phenyl, C₁_₆ monocyclic cycloalkyl, and C₂₋₄ alkenyl.

And, in some embodiments, the extraction agent comprises any combination of an amine, di-amine, and/or silamine such as any of those described herein.

In some embodiments, the extraction agent comprises (or is selected from) methylamine; ethylamine; propylamine; isopropylamine; butylamine; sec-butylamine; iso-butylamine; tert-butylamine; amylamine; hexylamine; heptylamine; 1-methylhexylamine; octylamine; 1-ethylpentylamine; 2-ethylhexylamine; 2-ethylbutylamine; 2-ethyl-1-hexylamine; tert-octylamine; nonylamine; decylamine; dodecylamine; hexadecylamine; octadecylamine; dimethylamine; diethylamine; dipropylamine; di-iso-propylamine; dibutylamine; di-sec-butylamine; di-iso-butylamine; di-tert-butylamine; diisobutylamine; N,N-ethylcyclohexylamine; N-methylcyclohexylamine; N-methyl-tert-butylamine; N-methyl-iso-butylamine; N-methylpentylamine; di-allylamine; N-ethylmethylamine; N-iso-propylmethylamine; N-methylbutylamine; N-methyl-n-amylamine; N-ethyl-tert-butylamine; N-ethyl-sec-butylamine; N-ethylpropylamine; N-ethyl-iso-propylamine; N-ethyl-n-butylamine; dioctylamine; N-methyldodecylamine; propylbutylamine; N-ethylbenzylamine; 1,3-dimethylbutylamine; N,N-dimethyl-iso-propylamine; dimethylpropylamine; N,N-dimethyl-iso-butylamine; N,N-dimethyl-tert-butylamine; N,N-dimethylcyclohexylamine; N,N-dimethylethylamine; N,N-diethylmethylamine; triethylamine; di-iso-propylmethylamine; 2-(isopropylamino)ethanol; tripropylamine; trioctylamine; N,N-dimethylhexadecylamine; 1,8-diaminooctane; 1,12-diaminododecane; 1,3-dimethylamylamine; 2-aminopentane; N,N,5,5-tetramethyl-1,3-dioxan-2amine; bis[3-trimethoxysilyl)propyl]amine; octanoic acid; decanoic acid; hexanoic acid; or any combination thereof. And, in some embodiments, the extraction agent comprises dipropylamine; di-iso-propylamine; or any combination thereof.

In some embodiments, the extraction agent comprises a tertiary or secondary amine having a molecular weight of greater than about 200 g/mol. In some embodiments, the extraction agent comprises a tertiary or secondary amine having a molecular weight of greater than about 300 g/mol. In some embodiments, the extraction agent comprises a tertiary or secondary amine having a molecular weight of greater than about 400 g/mol. In other embodiments, the extraction agent comprises a tertiary or secondary amine having a molecular weight of greater than about 600 g/mol. In some embodiments, the extraction agent comprises a tertiary or secondary amine having a molecular weight of from about 200 g/mol to about 1,000 g/mol. In some embodiments, the extraction agent comprises a tertiary or secondary amine having a molecular weight of from about 300 g/mol to about 1,000 g/mol. And, in some embodiments, the extraction agent comprises a tertiary or secondary amine having a molecular weight of from about 400 g/mol to about 1,000 g/mol.

In some embodiments, the extraction agent may comprise an inorganic or organic acid addition salt of any the amines, di-amines, and/or silamines described herein. For example, the extraction agent may comprise an HCl salt of any of the amines, di-amines, and/or silamines described herein. In other embodiments, the extraction agent may comprise an octanoic acid salt of any of the amines, di-amines, and/or silamines described herein. And, in some embodiments, the extraction agent may comprise a fatty acid salt of any of the amines, di-amines, and/or silamines described herein.

In some embodiments, the extraction agent optionally comprises a co-solvent. In some embodiments, the optional co-solvent comprises methyl tert-butyl ether (MTBE); acetone; ammonia; methylethylketone; ethylene glycol; propylene glycol; methanol; ethanol; propanol; butanol; pentanol; hexanol; heptanol; octanol; nonanol; decanol; ethyl acetate; cyclopentanone; cyclohexanone; 2-ethyl-3-methylcyclopentan-1-one; 1,4-cyclohexanedione; 1,2-cyclohexanedione; ethyl methyl sulfone; butyl sulfone; dimethyl sulfone; benzyl sulfone; ethyl phenyl sulfone; 1-ethoxy-3-propoxy-2-propanol; 1-butoxy-3-methoxy-2-propanol; 1-propopxy-2-propanol; diethylene glycol-mono-n-butyl ether; tripropylene glycol-mono-butyl ether; di(propylene glycol) propyl ether; tri(propylene glycol) propyl ether; 4-butylmorpholine; 2,4-dimethyl-1,3-dioxane; or any combination thereof.

In some embodiments, the system further comprises one or more solar cells configured to provide electricity and/or heat for operation of the system.

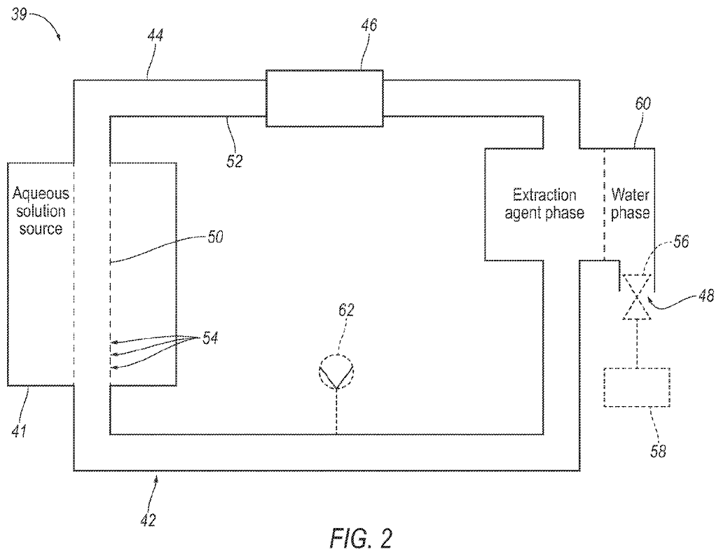

Referring to FIG. 2, another aspect of the present invention provides a system 39 for extracting water from an aqueous solution, wherein the system comprises a source of aqueous solution 41 and an extraction loop 42. The extraction loop comprises an extraction agent, a conduit 44, a heater 46, and a reversibly closable water outlet 48.

The conduit comprises a semi-permeable segment 50 and a non-permeable segment 52. The conduit is configured to permit the flow of at least a portion of the extraction agent through the semi-permeable segment and the non-permeable segment. As shown in FIG. 2, at least a portion of the semi-permeable segment contacts the source of aqueous solution and is configured to permit a portion of the aqueous solution to contact at least a portion of the extraction agent in the extraction loop. In this manner, the system facilitates mixing of the extraction agent and the aqueous solution.

In some embodiments, the semi-permeable segment of the conduit comprises a plurality of pores 54. In some embodiments, the pores have a mean pore size of from about 80 nm to about 1 μm. In other embodiments, the pores have a mean pore size of from about 5 Å to about 500 Å (e.g., from about 5 Å to about 500 Å, from about 5 Å to about 250 Å, from about 5 Å to about 100 Å, or from about 5 Å to about 50 Å). In some embodiments, the semi-permeable segment comprises a porosity giving a molecular weight cut off of from about 300 D to about 3,000 D. The semi-permeable segment may be comprised of any material suitable for facilitating contact between the aqueous solution and the extraction agent. The semi-permeable segment may comprise, by way of non-limiting example, a cellulose material, a polysulphone material, a polyamide material, a polyimide material, polytetrafluoroethylene (PTFE), polyvinylidene fluoride (PVDF), polyethylene oxide (PEO), polyphenylene oxide (PPO), polyvinyl chloride (PVC), chlorinated polyvinyl chloride (CPVC), polypropylene (PP), high-density polyethylene (HDPE), polyethylene (PE), or any combination thereof. In some embodiments, the semi-permeable membrane comprises a polyamide thin film composite (TFC). In other embodiments, the semi-permeable membrane comprises a cellulose acetate blend. In some embodiments, the semi-permeable membrane comprises regenerated cellulose.

In some embodiments, the semi-permeable segment of the conduit is configured to facilitate contact between the extraction agent and the aqueous solution under mixing conditions to form a wet extraction agent phase. In some embodiments, the semi-permeable segment is configured to limit (or exclude) the formation of any raffinate phase in the extraction loop. For example, the semi-permeable membrane permits the aqueous solution to contact the extraction agent such that water from the aqueous solution is absorbed by the extraction agent substantially free, or free, of any sodium chloride present in the aqueous solution. For example, the water absorbed by the extraction agent may have a concentration of sodium chloride that is from about 65% to about 99%, about 70% to about 99%, or about 65% to about 90% less than the concentration of sodium chloride in the aqueous solution.

The heater 46 thermally communicates with a portion of the extraction agent within a heated portion of the non-permeable segment. As shown in FIG. 2, the heater is downstream of the semi-permeable segment of the conduit. The portion of the extraction agent within the heated portion of the non-permeable segment is the wet extraction agent phase.

The heater is configured to heat the portion of extraction agent in thermal communication therewith (i.e., the wet extraction agent phase) from about ambient temperature to a temperature of from about 35° C. to about 130° C. (e.g., from about 40° C. to about 110° C., from about 45° C. to about 90° C., from about 50° C. to about 85° C., or from about 60° C. to about 80° C.) to form an extraction agent phase and a water phase. In some embodiments, the heater 46 comprises one or more heating elements. In some embodiments, the one or more heating elements is disposed within the heated portion of the non-permeable segment. In other embodiments, the non-permeable segment comprises a thermally conductive wall, and the one or more heating elements thermally communicates with the extraction agent via the thermally conductive wall.

With continued reference to FIG. 2, the reversibly closable water outlet 48 is in fluid communication with a portion of the non-permeable segment of the conduit and oriented downstream from the heater. The reversibly closable water outlet is configured to permit at least a portion of the water phase to exit the conduit while retaining from about 50% to about 100% by volume of the extraction agent phase in the conduit. In some embodiments, the reversibly closable water outlet comprises a reversibly closable valve 56. The reversibly closable valve may be any valve as described herein.

In some embodiments, the system further comprises an optional tank that fluidly communicates with the reversibly closable water outlet. For example, system comprises a water phase sparging tank 58 or other tank in fluid communication with the reversibly closable water outlet. When present, the water phase sparging tank is configured to sparge at least a portion of the water phase to remove at least a portion of any extraction agent from the water phase. In other examples, the tank comprises a filtration device, a distillation device, or both, wherein the filtration device and/or distillation device are configured to separate substantially pure water from the water phase. In these manners, the water phase can be recovered substantially free, or free, of the extraction agent.

In some embodiments, the water phase sparging tank may comprise a gas outlet. The gas outlet may be in fluid communication with the extraction loop via a sparging tank conduit. When the sparging tank conduit is present, extraction agent vaporized from the water phase in the water phase sparging tank may travel, as a gas, through the sparging tank conduit to the extraction loop as dry extraction agent. In some embodiments, the sparging tank conduit may further include a condenser to convert the gaseous vaporized extraction agent into liquid dry extraction agent. In this manner, any extraction agent removed from the water phase in the water phase sparging tank can be returned to the extraction loop.

In some embodiments, a portion of the non-permeable segment downstream from the heater comprises an optional second tank 60. When the second tank is present, the reversibly closable water outlet fluidly communicates with the second tank. In some embodiments, the second tank fluidly communicates with the heated portion of the non-permeable segment. In this manner, the second tank receives the extraction agent phase and the water phase from the non-permeable segment downstream from the heater.

In some embodiments, the system further comprises an actuator 62 in fluid communication with the extraction loop and configured to cycle the extraction agent and the extraction phase through the extraction loop. In some embodiments, the actuator comprises a pump. When the actuator comprises a pump, the pump may be any pump as described herein.

The extraction loop is configured to return at least a portion of the extraction agent phase to the semi-permeable segment of the conduit as extraction agent. In some embodiments, a portion of the non-permeable segment downstream from the heater is configured to permit the extraction agent phase to cool to a temperature of from about ambient temperature to about 34° C. before returning to the semi-permeable segment. For example, the non-permeable segment downstream from the heater and the tank may comprise an optional cooling device to cool the extraction agent phase heated in the heated portion of the non-permeable segment.

The aqueous solution may be any aqueous solution as described herein. The aqueous solution may have any concentration of sodium chloride as described herein. The aqueous solution may have any concentration of TDS as described herein.

The extraction agent may include any extraction agent as described herein. In some embodiments, the extraction agent comprises a co-solvent as described herein.

The water phase has a concentration of sodium chloride that is less than the concentration of sodium chloride in the aqueous solution. The water phase may have any concentration of sodium chloride as described herein. The water phase may be substantially free, or free, of the extraction agent as described herein. The water phase may have any concentration of TDS as described herein.

In some embodiments, the system further comprises one or more solar cells configured to provide electricity and/or heat for operation of the system.

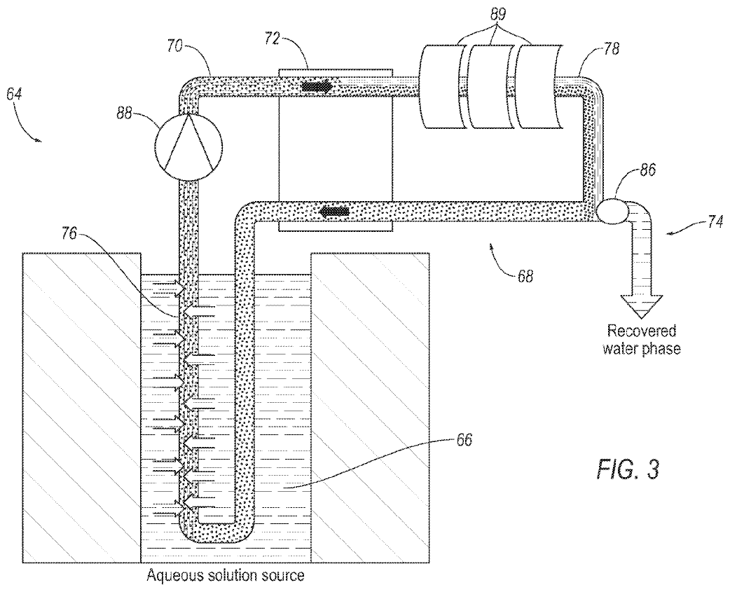

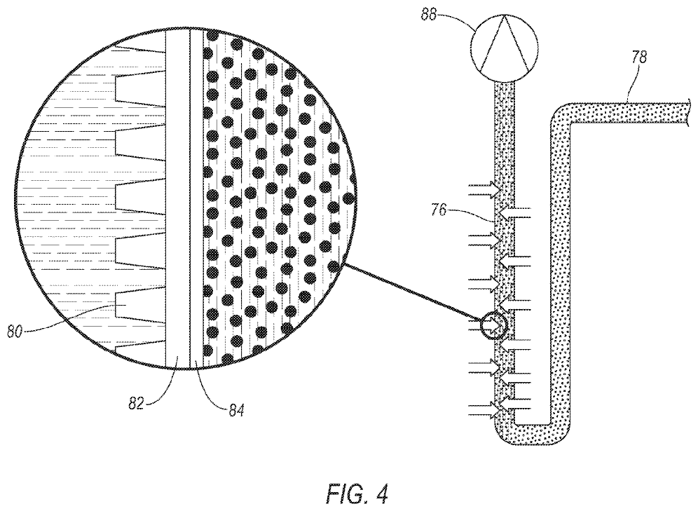

Referring to FIGS. 3 and 4, another aspect of the present invention provides a system 64 for extracting water from an aqueous solution, wherein the system comprises a source of aqueous solution 66 and an extraction loop 68. The extraction loop comprises an extraction agent, a conduit 70, a heater 72, and a reversibly closable water outlet 74.

The conduit comprises a semi-permeable segment 76 and a non-permeable segment 78. The conduit is configured to permit the flow of at least a portion of the extraction agent through the semi-permeable segment and the non-permeable segment. As shown in FIG. 3, at least a portion of the semi-permeable segment contacts the source of aqueous solution and is configured to permit a portion of the aqueous solution to contact at least a portion of the extraction agent in the extraction loop. In this manner, the system facilitates mixing of the extraction agent and the aqueous solution. In some embodiments, as shown in FIG. 3, the source of aqueous solution may be a well and at least a portion of the extraction loop (e.g., the semi-permeable segment) may be disposed in the well.

In some embodiments, the semi-permeable segment of the conduit comprises a plurality of pores (not shown). The pores may have any mean pore size and any porosity giving a molecular weight cutoff as described herein. The semi-permeable segment may comprise any material as described herein.

In some embodiments (as shown in FIG. 4), the semi-permeable segment comprises a perforated pipe 80, a semi-permeable membrane (e.g., a polyamide membrane) 82, and a sealant 84. The pipe may be a metal (e.g., steel) pipe. The semi-permeable membrane comprise any material described herein. For example, the semi-permeable membrane may comprise a polyamide material (e.g., an aramid material). In some examples, the sealant is selected from any sealant that does not substantially reduce the permeability of the semi-permeable membrane. And, in some examples, the sealant may be a salinity dependent sealant.

In some embodiments, the semi-permeable segment of the conduit is configured to facilitate contact between the extraction agent and the aqueous solution under mixing conditions to form a wet extraction agent phase. In some embodiments, the semi-permeable segment is configured to limit (or exclude) the formation of any raffinate phase in the extraction loop. For example, the semi-permeable membrane permits the aqueous solution to contact the extraction agent such that water from the aqueous solution is absorbed by the extraction agent substantially free, or free, of any sodium chloride present in the aqueous solution. For example, the water absorbed by the extraction agent may have a concentration of sodium chloride that is from about 65% to about 99%, about 70% to about 99%, or about 65% to about 90% less than the concentration of sodium chloride in the aqueous solution.

The heater thermally communicates with at least a portion of the extraction agent within a heated portion of the non-permeable segment. As shown in FIG. 3, the heater is downstream of the semi-permeable segment of the conduit. The portion of the extraction agent within the heated portion of the non-permeable segment is the wet extraction agent phase.

The heater is configured to heat the portion of extraction agent in thermal communication therewith (i.e., the wet extraction agent phase) from about ambient temperature to a temperature of from about 35° C. to about 130° C. (e.g., from about 40° C. to about 110° C., from about 45° C. to about 90° C., from about 50° C. to about 85° C., or from about 60° C. to about 80° C.) to form an extraction agent phase and a water phase. In some embodiments, the heater comprises one or more heating elements. In some embodiments, the one or more heating elements is disposed within the heated portion of the non-permeable segment. In other embodiments, the non-permeable segment comprises a thermally conductive wall, and the one or more heating elements thermally communicates with the extraction agent via the thermally conductive wall. In some embodiments, the heater is a heat exchanger.

The reversibly closable water outlet fluidly communicates with a portion of the non-permeable segment of the conduit oriented downstream from the heater. The reversibly closable water outlet is configured to permit at least a portion of the water phase to exit the conduit while retaining from about 50% to about 100% by volume of the extraction agent phase in the conduit. In some embodiments, the reversibly closable water outlet comprises a reversibly closable valve 86. The reversibly closable valve may be any valve as described herein.

In some embodiments, the system further comprises an optional tank that fluidly communicates with the reversibly closable water outlet. For example, system comprises a water phase sparging tank (not shown) or other tank in fluid communication with the reversibly closable water outlet. When present, the water phase sparging tank is configured to sparge at least a portion of the water phase to remove at least a portion of any extraction agent from the water phase. In other examples, the tank comprises a filtration device or distillation device or both, wherein the filtration device and/or distillation device are configured to separate substantially pure water from the water phase. In these manners, the water phase can be recovered substantially free, or free, of the extraction agent.

In some embodiments, a portion of the non-permeable segment downstream from the heater comprises an optional second tank (not shown). When the second tank is present, the reversibly closable water outlet fluidly communicates with the second tank. In some embodiments, the second tank fluidly communicates with the heated portion of the non-permeable segment. In this manner, the second tank receives the extraction agent phase and the water phase from the non-permeable segment downstream from the heater.

In some embodiments, the system further comprises an actuator 88 in fluid communication with the extraction loop and configured to cycle the extraction agent and the extraction phase through the extraction loop. In some embodiments, the actuator comprises a pump. When the actuator comprises a pump, the pump may be any pump as described herein.

The extraction loop is configured to return at least a portion of the extraction agent phase to the semi-permeable segment of the conduit as extraction agent. In some embodiments, a portion of the non-permeable segment downstream from the heater is configured to permit the extraction agent phase to cool to a temperature of from about ambient temperature to about 34° C. before reaching the semi-permeable segment. For example, the non-permeable segment downstream from the heater and the tank may comprise an optional cooling device to cool the extraction agent phase heated in the heated portion of the non-permeable segment.

The aqueous solution may be any aqueous solution as described herein. The aqueous solution may have any concentration of sodium chloride as described herein. The aqueous solution may have any concentration of TDS as described herein.

The extraction agent may include any extraction agent as described herein. In some embodiments, the extraction agent comprises a co-solvent as described herein.

The water phase has a concentration of sodium chloride that is less than the concentration of sodium chloride in the aqueous solution. The water phase may have any concentration of sodium chloride as described herein. The water phase may be substantially free, or free, of the extraction agent as described herein. The water phase may have any concentration of TDS as described herein.

In some embodiments, the system further comprises one or more solar cells 89 configured to provide electricity and/or heat for operation of the system.

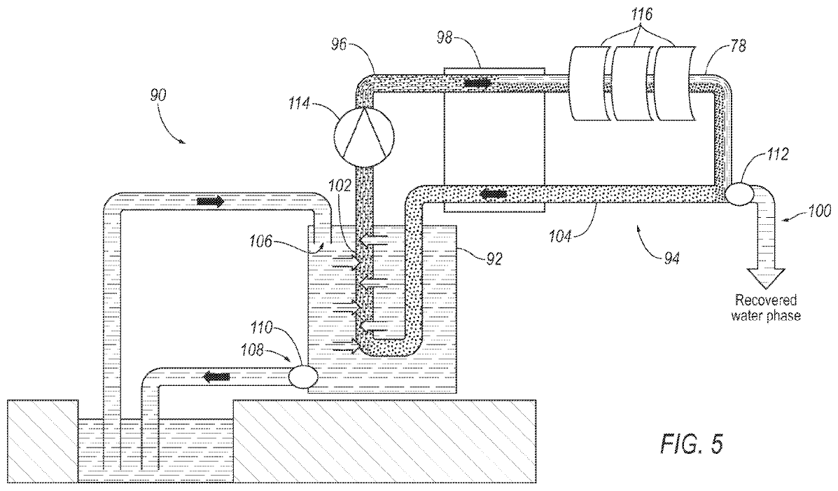

Referring to FIG. 5, another aspect of the present invention provides a system 90 for extracting water from an aqueous solution, wherein the system comprises a source of aqueous solution 92 and an extraction loop 94. The extraction loop comprises an extraction agent, a conduit 96, a heater 98, and a reversibly closable water outlet 100.

The conduit comprises a semi-permeable segment 102 and a non-permeable segment 104. The conduit is configured to permit the flow of at least a portion of the extraction agent through the semi-permeable segment and the non-permeable segment. As shown in FIG. 5, at least a portion of the semi-permeable segment contacts aqueous solution in the source of aqueous solution and is configured to permit a portion of the aqueous solution to contact at least a portion of the extraction agent within the extraction loop. In this manner, the system facilitates mixing of the extraction agent and the aqueous solution.

In some embodiments, as shown in FIG. 5, the source of aqueous solution may be an aqueous solution tank and at least a portion of the extraction loop (e.g., the semi-permeable segment) may be disposed in the aqueous solution tank. The aqueous solution tank may include a source inlet 106 and a source outlet 108. Each of the source inlet and source outlet are in fluid communication with the aqueous solution in the source of aqueous solution (e.g., the ocean, a well, etc.) for removing aqueous solution from the source and returning aqueous solution to the source. In some embodiments, the aqueous solution tank comprises a filtration device 110 in fluid communication with the source outlet and configured to remove extraction agent from the aqueous solution being returned to the source. In his manner, the aqueous solution can be returned to the body of water substantially free, or free, of extraction agent.

In some embodiments, the semi-permeable segment of the conduit comprises a plurality of pores (not shown). The pores may have any mean pore size and any porosity giving a molecular weight cutoff as described herein. The semi-permeable segment may comprise any material as described herein.

In some embodiments, the semi-permeable segment of the conduit is configured to facilitate contact between the extraction agent and the aqueous solution under mixing conditions to form a wet extraction agent phase. In some embodiments, the semi-permeable segment is configured to limit (or exclude) the formation of any raffinate phase in the extraction loop. For example, the semi-permeable membrane permits the aqueous solution to contact the extraction agent such that water from the aqueous solution is absorbed by the extraction agent substantially free, or free, of any sodium chloride present in the aqueous solution. For example, the water absorbed by the extraction agent may have a concentration of sodium chloride that is from about 65% to about 99%, about 70% to about 99%, or about 65% to about 90% less than the concentration of sodium chloride in the aqueous solution.

The heater thermally communicates with a portion of the extraction agent within a heated portion of the non-permeable segment. As shown in FIG. 5, the heater is downstream of the semi-permeable segment of the conduit. The portion of the extraction agent within the heated portion of the non-permeable segment is the wet extraction agent phase.

The heater is configured to heat the portion of extraction agent in thermal communication therewith (i.e., the wet extraction agent phase) from about ambient temperature to a temperature of from about 35° C. to about 130° C. (e.g., from about 40° C. to about 110° C., from about 45° C. to about 90° C., from about 50° C. to about 85° C., or from about 60° C. to about 80° C.) to form an extraction agent phase and a water phase. In some embodiments, the heater comprises one or more heating elements. In some embodiments, the one or more heating elements is disposed within the heated portion of the non-permeable segment. In other embodiments, the non-permeable segment comprises a thermally conductive wall, and the one or more heating elements thermally communicates with the extraction agent via the thermally conductive wall. In some embodiments, the heater is a heat exchanger.

With continued reference to FIG. 5, the reversibly closable water outlet is in fluid communication with a portion of the non-permeable segment of the conduit and oriented downstream from the heater. The reversibly closable water outlet is configured to permit at least a portion of the water phase to exit the conduit while retaining from about 50% to about 100% by volume of the extraction agent phase in the conduit. In some embodiments, the reversibly closable water outlet comprises a reversibly closable valve 112. The reversibly closable valve may be any valve as described herein.

In some embodiments, the system further comprises an optional tank that fluidly communicates with the reversibly closable water outlet. For example, system comprises a water phase sparging tank (not shown) or other tank in fluid communication with the reversibly closable water outlet. When present, the water phase sparging tank is configured to sparge at least a portion of the water phase to remove at least a portion of any extraction agent from the water phase. In other examples, the tank comprises a filtration device or distillation device or both, wherein the filtration device and/or distillation device are configured to separate substantially pure water from the water phase. In these manners, the water phase can be recovered substantially free, or free, of the extraction agent.

In some embodiments, a portion of the non-permeable segment downstream from the heater comprises an optional second tank (not shown). When the second tank is present, the reversibly closable water outlet fluidly communicates with the second tank. In some embodiments, the second tank fluidly communicates with the heated portion of the non-permeable segment. In this manner, the second tank receives the extraction agent phase and the water phase from the non-permeable segment downstream from the heater.

In some embodiments, the system further comprises an actuator 114 in fluid communication with the extraction loop and configured to cycle the extraction agent and the extraction phase through the extraction loop. In some embodiments, the actuator comprises a pump. When the actuator comprises a pump, the pump may be any pump as described herein.

The extraction loop is configured to return at least a portion of the extraction agent phase to the semi-permeable segment of the conduit as extraction agent. In some embodiments, a portion of the non-permeable segment downstream from the heater is configured to permit the extraction agent phase to cool to a temperature of from about ambient temperature to about 34° C. before reaching the semi-permeable segment. For example, the non-permeable segment downstream from the heater and the tank may comprise an optional cooling device to cool the extraction agent phase heated in the heated portion of the non-permeable segment.

The aqueous solution may be any aqueous solution as described herein. The aqueous solution may have any concentration of sodium chloride as described herein. The aqueous solution may have any concentration of TDS as described herein.

The extraction agent may include any extraction agent as described herein. In some embodiments, the extraction agent comprises a co-solvent as described herein.

The water phase has a concentration of sodium chloride that is less than the concentration of sodium chloride in the aqueous solution. The water phase may have any concentration of sodium chloride as described herein. The water phase may be substantially free, or free, of the extraction agent as described herein. The water phase may have any concentration of TDS as described herein.

In some embodiments, the system further comprises one or more solar cells 116 configured to provide electricity and/or heat for operation of the system.

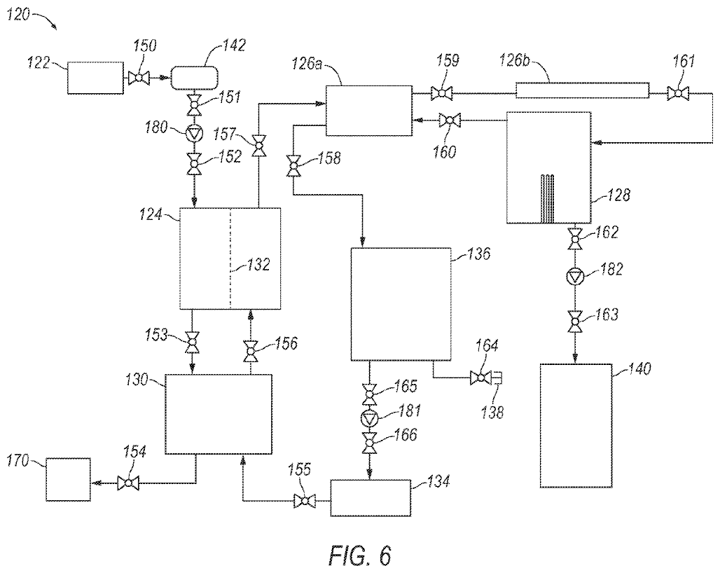

Referring to FIG. 6, another aspect of the present invention provides a system 120 for extracting water from an aqueous solution, wherein the system comprises a source of aqueous solution 122 (e.g., a well, sea, or other body of water) and an extraction loop, wherein the extraction loop comprises a membrane interface 124, a heater 126a, a separation tank 128, and a cooler 130.

Extraction agents suited for use in this system include any extraction agent described herein having a density less than the density the aqueous solution under isothermal conditions.

The membrane interface comprises a semi-permeable membrane 132, such as any semi-permeable membrane described herein, configured as a semi-permeable interface between the aqueous solution and the extraction agent within the extraction loop permitting the aqueous solution and/or water from the aqueous solution to mix with the extraction agent in the extraction loop to generate wet extraction agent within the extraction loop.

In some embodiments, the semi-permeable membrane comprises a plurality of pores. In some embodiments, the pores have a mean pore size of from about 80 nm to about 1 μm. In some embodiments, the semi-permeable membrane comprises a porosity that gives a molecular weight cut off of from about 300 D to about 3,000 D. The semi-permeable membrane may be comprised of any material suitable for facilitating contact between the aqueous solution and the extraction agent. The semi-permeable membrane may comprise, by way of non-limiting examples, a cellulose material, a polysulphone material, a polyamide material, a polyimide material, polytetrafluoroethylene (PTFE), polyvinylidene fluoride (PVDF), polyethylene oxide (PEO), polyphenylene oxide (PPO), polyvinyl chloride (PVC), chlorinated polyvinyl chloride (CPVC), polypropylene (PP), high-density polyethylene (HDPE), polyethylene (PE), or any combination thereof. In some embodiments, the semi-permeable membrane comprises a polyamide thin film composite (TFC). In other embodiments, the semi-permeable membrane comprises a cellulose acetate blend. In some embodiments, the semi-permeable membrane comprises regenerated cellulose.

Suitable semi-permeable membranes comprising a polyamide TFC are commercially available under trade names such as, for example, Filmtec™ (e.g., SeaMaxx 47 mm, SeaMaxx CFO16, SeaMaxx CF042, XC70 47 mm, XC70, CFO16, and XC70 CF042) from Dupont (Wilmington, Delaware); and TRISEP® (e.g., TS80 47 mm, TS80 CF016, and TS80 CF042) from MANN+HUMMEL (Ludwigsburg, Germany). Suitable semi-permeable membranes comprising a polyamide TFC are also commercially available from Suez (Germany) (e.g., Suez AK 47 mm, Seuz AK CFO16, and Suez AK CF042). Suitable semi-permeable membranes comprising a cellulose acetate blend are commercially available under trade names such as TRISEP® (e.g., SB90 47 mm, SB90 CF016, and SB90 CF042) from MANN+HUMMEL (Ludwigsburg, Germany). Suitable semi-permeable membranes comprising regenerated cellulose are commercially available from Carolina Biological Supply (Burlington, North Carolina).

With continued reference to FIG. 6, in some embodiments, the heater is configured to heat wet extraction agent in the extraction loop from a temperature of from about 5° C. (e.g., from 5° C. to about 15° C.) to a temperature of greater than about 45° C. (e.g., from about 50° C. to about 65° C.). In some embodiments, the heater is a regenerative heat exchanger. Some embodiments, further comprise an optional second heater comprising a solar array 126b.

The separation tank is configured to allow the heated wet extraction agent to settle into a bi-phasic mixture comprising a water layer (bottom layer) and a dry extraction agent layer (top layer). In some embodiments, the separator tank comprises a water outlet configured to permit all or substantially all of the water layer to be removed from the tank free (or substantially free) of the dry extraction layer. In some embodiments, the separator tank comprises an extraction agent outlet configured to permit all or substantially all of the dry extraction agent layer to be removed from the tank. In some embodiments, the extraction agent outlet fluidly communicates with the regenerative heat exchanger.

The cooler collects heated dry extraction agent in the extraction loop and operates to cool the heated dry extraction agent to a temperature of less than about 20° C. (e.g., from about from 5° F. to about 15° F.) before the extraction agent is conveyed to the membrane interface. In some embodiments, the aqueous solution downstream of the membrane interface (having a lower temperature than the heated dry extraction agent) creates a negative temperature differential in the cooler that reduces the temperature of the heated dry extraction agent. In some embodiments, the extraction loop further comprises at least one radiator 134 immediately upstream from the cooler that operates to shed thermal energy from the heated dry extraction agent to the environment.

Some systems optionally comprise an extraction agent tank 136 downstream from the separation tank and upstream from the cooler, wherein the extraction agent tank comprises a drain 138 configured to drain any fugitive water that could be present in the dry extraction agent. In some embodiments, when the heater comprises a regenerative heat exchanger, the extraction agent tank is downstream from the heat exchanger and upstream from the cooler.

Some embodiments optionally comprise a filter 140 (e.g., a granular activated carbon filter) fluidly communicating with the water outlet of the separator tank. And, some embodiments optionally comprise a strainer 142 interposed between the source of aqueous solution and the membrane interface. Optional valves, 150-166, can be suitably arranged between distinct components and devices of the extraction loop, between the source of aqueous solution and the extraction loop, and/or between the extraction loop and the aqueous solution return 170. Likewise, optional pumps 180-182 can be positioned at any suitable location(s) in the extraction loop, between the extraction loop and the source of aqueous solution, and/or between the extraction loop and the aqueous solution return.

### III. METHOD FOR EXTRACTING WATER FROM AN AQUEOUS SOLUTION

Another aspect of the present invention provides a method of extracting water from an aqueous solution comprising:
(a) contacting an extraction agent with the aqueous solution through a semi-permeable membrane at about ambient temperature to form a wet extraction agent phase, wherein the aqueous solution has a concentration of sodium chloride;
(b) heating the wet extraction agent phase to a temperature of from about 35° C. to about 130° C. to form a heated mixture comprising a dry extraction agent phase and a water phase, wherein the water phase comprises a concentration of sodium chloride that is less than the concentration of sodium chloride in the aqueous solution; and
(c) recycling at least a portion of the dry extraction agent phase for use as extraction agent in mixing step (a).

In some implementations, the semi-permeable membrane comprises a plurality of pores. In some implementations, the pores may have a mean pore size of from about 80 nm to about 1 μm. In some implementations, the semi-permeable membrane comprises a porosity that gives a molecular weight cut off of from about 300 D to about 3,000 D. In some implementations, the semi-permeable membrane comprises a cellulose material, a polysulphone material, a polyamide material, a polyimide material, polytetrafluoroethylene (PTFE), polyvinylidene fluoride (PVDF), polyethylene oxide (PEO), polyphenylene oxide (PPO), polyvinyl chloride (PVC), chlorinated polyvinyl chloride (CPVC), polypropylene (PP), high-density polyethylene (HDPE), polyethylene (PE), or any combination thereof. In some embodiments, the semi-permeable membrane comprises a polyamide thin film composite (TFC). In other embodiments, the semi-permeable membrane comprises a cellulose acetate blend. In some embodiments, the semi-permeable membrane comprises regenerated cellulose.

The aqueous solution comprises a concentration of sodium chloride. The aqueous solution may comprise any concentration of sodium chloride as described herein. In some implementations, the aqueous solution has a concentration of sodium chloride of from about 300 mg/L to about 45,000 mg/L (e.g., from about 30,000 mg/L to about 40,000 mg/L, from about 500 mg/L to about 30,000 mg/L, or greater than about 45,000 mg/L). The aqueous solution may comprise, by way of non-limiting example, seawater; well water; brackish water; briny water; or any combination thereof. For example, the aqueous solution may be seawater or well water.

In some implementations, the aqueous solution comprises a concentration of TDS. The aqueous solution may comprise any concentration of TDS as described herein.

The extraction agent is any extraction agent as described herein. In some implementations, the extraction agent comprises a co-solvent such as any co-solvent described herein.

In some implementations, step (b) comprises heating the wet extraction agent phase to a temperature of from about 35° C. to about 130° C. (e.g., from about 40° C. to about 110° C., from about 45° C. to about 90° C., from about 50° C. to about 85° C., or from about 60° C. to about 80° C.). In other implementations, step (b) comprises heating the wet extraction agent phase to a temperature of from about 50° C. to about 85° C. And, in some implementations, step (b) comprises heating the wet extraction agent phase to a temperature of from about 60° C. to about 80° C.

In some implementations, step (b) comprises maintaining the temperature of the heated wet extraction agent phase for a period of from about 30 s to about 5 min. For example, step (b) comprises maintaining the temperature of the heated wet extraction agent phase at a temperature of from about 45° C. to about 90° C. for a period of from about 30 s to about 5 min. In other implementations, step (b) comprises maintaining the temperature of the heated wet extraction agent phase for a period of from about 30 s to about 10 min. In some implementations, step (b) comprises maintaining the temperature of the heated wet extraction agent phase for a period of from about 2.5 min to about 7.5 min. And, in some implementations, step (b) comprises maintaining the temperature of the heated wet extraction agent phase for a period of about 5 min.

In some implementations, the heating of step (b) is performed by one or more solar-powered heating elements. In this manner, the method further reduces costs associated with the heating process.

The water phase has a concentration of sodium chloride that is less than the concentration of sodium chloride in the aqueous solution. The water phase may have any concentration of sodium chloride as described herein. For example, the water phase may have a concentration of sodium chloride that is from about 70% to about 99% less than the concentration of sodium chloride in the aqueous solution.

In some implementations, the water phase has a concentration of TDS. The water phase may have any concentration of TDS as described herein.

In some implementations, step (b) comprises:
(b-1) treating at least a portion of the water phase to remove extraction agent. For example, step (b-1) comprises treating the portion of the water phase by sparging or filtering with an osmotic filter. In this manner, the method ensures that the water phase is substantially free, or free, of the extraction agent.

Another aspect of the present invention provides a method of extracting water from an aqueous solution. The method comprises:
(aa) contacting an extraction agent with the aqueous solution through a semi-permeable membrane at about ambient temperature to form a wet extraction agent phase, wherein the aqueous solution has a concentration of TDS;
(bb) heating the wet extraction agent phase to a temperature of from about 35° C. to about 130° C. to form a heated mixture comprising a dry extraction agent phase and a water phase, wherein the water phase comprises a concentration of TDS that is less than the concentration of TDS in the aqueous solution; and
(cc) recycling at least a portion of the dry extraction agent phase for use as extraction agent in mixing step (a).

Any system described herein may be suitable for any implementation of any method described herein.

Another aspect of the present invention provides a method of extracting water from an aqueous solution comprising:
(aI) absorbing water in an extraction agent from a feed stream of aqueous solution through a semi-permeable membrane at a temperature of no more than 27° C. (e.g., from about 8° C. to about 21° C.) to form a wet extraction agent phase, wherein the aqueous solution has a concentration of sodium chloride;
(bI) heating the wet extraction agent phase to a temperature of from about 35° C. to about 90° C. to form a heated mixture comprising a dry extraction agent phase and a water phase, wherein the water phase comprises a concentration of sodium chloride that is less than the concentration of sodium chloride in the aqueous solution; and
(cI) cooling the heated dry extraction agent phase using the feed stream of aqueous solution; and
(dI) recycling at least a portion of the dry extraction agent phase for use as extraction agent in mixing step (a).

In some implementations, the semi-permeable membrane comprises a plurality of pores. In some implementations, the pores may have a mean pore size of from about 80 nm to about 1 μm. In some implementations, the semi-permeable membrane comprises a porosity that gives a molecular weight cut off of from about 300 D to about 3,000 D. In some implementations, the semi-permeable membrane comprises a cellulose material, a polysulphone material, a polyamide material, a polyimide material, polytetrafluoroethylene (PTFE), polyvinylidene fluoride (PVDF), polyethylene oxide (PEO), polyphenylene oxide (PPO), polyvinyl chloride (PVC), chlorinated polyvinyl chloride (CPVC), polypropylene (PP), high-density polyethylene (HDPE), polyethylene (PE), or any combination thereof. In some embodiments, the semi-permeable membrane comprises a polyamide thin film composite (TFC). In other embodiments, the semi-permeable membrane comprises a cellulose acetate blend. In some embodiments, the semi-permeable membrane comprises regenerated cellulose.

The aqueous solution comprises a concentration of sodium chloride. The aqueous solution may comprise any concentration of sodium chloride as described herein. In some implementations, the aqueous solution has a concentration of sodium chloride of from about 300 mg/L to about 45,000 mg/L (e.g., from about 30,000 mg/L to about 40,000 mg/L, from about 500 mg/L to about 30,000 mg/L, or greater than about 45,000 mg/L). The aqueous solution may comprise, by way of non-limiting example, seawater; well water; brackish water; briny water; or any combination thereof. For example, the aqueous solution may be seawater or well water.

In some implementations, the aqueous solution comprises a concentration of TDS. The aqueous solution may comprise any concentration of TDS as described herein.

The extraction agent is any extraction agent as described herein. In some implementations, the extraction agent comprises a co-solvent such as any co-solvent described herein.

In some implementations, step (bI) comprises heating the wet extraction agent phase to a temperature of from about 35° C. to about 130° C. (e.g., from about 40° C. to about 110° C., from about 45° C. to about 90° C., from about 50° C. to about 85° C., or from about 60° C. to about 80° C.). In other implementations, step (b) comprises heating the wet extraction agent phase to a temperature of from about 50° C. to about 85° C. And, in some implementations, step (b) comprises heating the wet extraction agent phase to a temperature of from about 60° C. to about 80° C.

In some implementations, step (b) comprises maintaining the temperature of the heated wet extraction agent phase for a period of from about 30 s to about 5 min. For example, step (b) comprises maintaining the temperature of the heated wet extraction agent phase at a temperature of from about 45° C. to about 90° C. for a period of from about 30 s to about 5 min. In other implementations, step (b) comprises maintaining the temperature of the heated wet extraction agent phase for a period of from about 30 s to about 10 min. In some implementations, step (b) comprises maintaining the temperature of the heated wet extraction agent phase for a period of from about 2.5 min to about 7.5 min. And, in some implementations, step (b) comprises maintaining the temperature of the heated wet extraction agent phase for a period of about 5 min.

In some implementations, the heating of step (bI) is performed by one or more solar-powered heating elements or solar arrays. In this manner, the method further reduces costs associated with the heating process.

The water phase has a concentration of sodium chloride that is less than the concentration of sodium chloride in the aqueous solution. The water phase may have any concentration of sodium chloride as described herein. For example, the water phase may have a concentration of sodium chloride that is from about 70% to about 99% less than the concentration of sodium chloride in the aqueous solution.

In some implementations, the water phase has a concentration of TDS. The water phase may have any concentration of TDS as described herein.

In some implementations, step (b) comprises:
(b-1) treating at least a portion of the water phase to remove extraction agent. For example, step (b-1) comprises treating the portion of the water phase by sparging or filtering with an osmotic filter. In this manner, the method ensures that the water phase is substantially free, or free, of the extraction agent.

Another aspect of the present invention provides a method of extracting water from an aqueous solution. The method comprises:

### IV. EXAMPLES

### Example 1: Extraction of Water from a 0.6M NaCl Solution

General Method: The following method is an exemplary method of Example 1.

The extraction agent (100 mL) and the aqueous solution (100 mL) were mixed in a 500 mL separatory funnel at ambient temperature for about one (1) minute. A wet extraction agent phase (less dense; top layer) and a raffinate phase (more dense; bottom layer) were allowed to form and separate. The raffinate phase was removed and the wet extraction agent phase was transferred to a graduated cylinder. The wet extraction agent phase was heated at about 85° C. for about 5 minutes. The heated wet extraction agent phase reached a temperature of from about 65° C. to about 75° C. and formed a heated extraction agent phase (less dense; top layer) and a heated aqueous solution phase (more dense; bottom layer). A portion of the heated extraction agent phase was removed to provide a balanced mixture having a volume ratio of 1:1 of heated extraction agent phase to heated aqueous solution phase. The balanced mixture was allowed to cool to about 21° C. and the balanced mixture was transferred to a separatory funnel. The balanced mixture was mixed for one (1) minute. A cooled extraction agent phase (less dense; top layer) and a cooled aqueous solution phase (more dense, bottom layer) were allowed to form and separate. The cooled aqueous solution phase was removed and the cooled extraction agent phase was transferred to a graduated cylinder. The cooled extraction agent phase was heated at about 85° C. for 5 minutes. The cooled extraction agent phase reached a temperature of from about 65° C. to about 75° C. and formed a dry extraction agent phase (less dense; top layer) and a water phase (more dense; bottom layer). The water phase was recovered and its salt concentration was analyzed via gravimetric analysis.

In some General Method Runs, one or both of the extraction agent and the aqueous solution were dyed, as indicated in Table 1. Other General Method Runs were modified as indicated in the tables below.

Aqueous solutions: 0.6M NaCl solutions were prepared by placing 35.000 g of NaCl in a 1 L Class B volumetric flask. Deionized water (700 mL) was added to the volumetric flask and the volumetric flask was swirled and inverted at least three times. Additional deionized water was added as necessary to reach the graduated mark of the volumetric flask. The mass of the resultant NaCl solution was determined by gravimetric analysis.

Extraction Agents: Dipropylamine, was used as the extraction agent. In the tables below, dipropylamine is referred to as “DPA”.

Gravimetric Analysis: For gravimetric analysis, the recovered water phase was dried in an oven at 66° C. until the water was removed and only salt remained. The mass of the remaining salt was determined and used to calculate the salt concentration of the water phase.

Dyes for Aqueous Solution and Extraction Agent: For the aqueous solutions, methylene blue (GAS: 61-73-4) was used as a dye. For the extraction agent, isopropyl alcohol (CAS 67-63-0) saturated with Sudan III (CAS: 85-86-9) was used as a dye.

The specific methods used in extraction runs 1-12 are set forth in Table 1A below.

TABLE 1A
Extraction methods used in runs 1-12.

| | Volume | | Aqueous | Water | |
|---|---|---|---|---|---|
| | Ratio of | | Solution | Bath | |
| Run | Balanced | Extraction | NaCl | Temp | |
| # | Mixture1 | Agent | Molarity (M) | (° C.) | Description |
| 1 | 1:1 | DPA | 0.601813826 | 90 | Dyed extraction agent |
| 2 | 1:1 | DPA | 0.602498289 | 85 | Dyed extraction agent and |
| | | | | | aqueous solution |
| 3 | 1:1 | DPA | 0.602156058 | 85 | Dyed extraction agent |
| 4 | 1:1 | DPA | 0.610198494 | 85 | Dyed extraction agent |
| 5 | 1:1 | DPA | 0.601471595 | 85 | No dyes |
| 6 | 1:1 | DPA | 0.602984942 | 85 | Wet extraction agent phase |
| | | | | | heated for 8 minutes instead |
| | | | | | of 5 minutes |
| 7 | 1:1 | DPA | 0.603524983 | 90 | Recycled extraction agent |
| | | | | | used (i.e., extraction agent |
| | | | | | used in a previous run and |
| | | | | | recovered in the heated |
| | | | | | extraction agent phase and/or |
| | | | | | dry extraction agent phase) |
| 8 | 1:1 | DPA | 0.608316222 | 95 | Balanced mixture formed |
| | | | | | while actively heating (i.e., |
| | | | | | portion of the heated |
| | | | | | extraction agent removed |
| | | | | | while in water bath) |
| 9 | 1:1 | DPA | 0.600901209 | 95 | |
| 10 | 2:1 | DPA | 0.616016427 | 95 | |
| 11 | 1:2 | DPA | 0.60523614 | 95 | |
| 12 | 1:1 | DPA | ~0.605065024 | 95 | 500 mL of aqueous solution |
| | | | | | mixed with 500 mL of |
| | | | | | extraction agent |
| | | | | | Wet extraction agent phase |
| | | | | | heated for 8 minutes instead |
| | | | | | of 5 minutes |

¹(heated extraction agent phase : heated aqueous solution phase)

The results of extraction runs 1-12 are set forth in Table 1B below.

TABLE 1B
Results of extraction runs 1-12.

| | | | | Water |
|---|---|---|---|---|
| | Water | Water | Water | Phase |
| | Phase | Phase | Phase | NaCl |
| | Molarity | NaCl Conc. | Volume | Recovered |
| Run # | (M) | (mg/kg) | (mL) | (g) |
| 1 | 5.9518495E−03 | 347.83 | 1.1500 | 0.0004 |
| 2 | 0.012833676 | 750.00 | 0.8000 | 0.0006 |
| 3 | 0.045630846 | 2666.67 | 0.9000 | 0.0024 |
| 4 | 0.044001173 | 2571.43 | 0.7000 | 0.0020 |
| 5 | 0.021778359 | 1272.73 | 1.1000 | 0.0014 |
| 6 | 0.01818104 | 1062.50 | 1.6000 | 0.0017 |
| 7 | 0.017111567 | 1000.00 | 1.2000 | 0.0012 |
| 8 | 0.015400411 | 900.00 | 1.0000 | 0.0009 |
| (1^{st} weigh) | | | | |
| 8 | 0.011978097 | 700.00 | 1.0000 | 0.0007 |
| (2^{nd} Weigh) | | | | |
| 8 | 0.01026694 | 600.00 | 1.0000 | 0.0006 |
| (3^{rd} Weigh) | | | | |
| 9 | 0.005703855807 | 333.33 | 1.2000 | 0.0004 |
| (1^{st} Weigh) | | | | |
| 9 | 0.011407712 | 666.67 | 1.2000 | 0.0008 |
| (2^{nd} Weigh) | | | | |
| 9 | 0.012833676 | 750.00 | 1.2000 | 0.0009 |
| (3^{rd} Weigh) | | | | |
| 10 | 0.011978097 | 700.00 | 2.0000 | 0.0014 |
| 11 | 0.01425964 | 833.33 | 0.6000 | 0.0005 |
| 12 | 0.010790122 | 1046.15 | 6.5000 | 0.0068 |
| (1^{st} & 2^{nd} | | | | |
| Weigh) | | | | |
| 12 | 0.017374822 | 1015.38 | 6.5000 | 0.0066 |
| (3^{rd} Weigh) | | | | |
| 12 | 0.016321803 | 953.85 | 6.5000 | 0.0062 |
| (4^{th}, 5^{th}, & | | | | |
| 6^{th} Weigh) | | | | |
| 12 | 0.016848313 | 984.62 | 6.5000 | 0.0064 |
| (Final Weigh) | | | | |

Conductivity Reading Compensated for Trace Extraction Agent (Run 12): Another technique used to measure the water phase was conductivity. For accuracy, conductivity analysis was only performed on the water phase of Run 12 due to the larger volume of water phase recovered. It was believed that the presence of extraction agent in the water phase would impact the conductivity measurement of the water phase.

To compensate for the impact of the extraction agent on the conductivity of the water phase, a 3000 mg/kg NaCl solution (Solution 1) and a 3000 mg/kg NaCl solution with trace extraction agent (Solution 2) were prepared. The conductivities of Solution 1 and Solution 2 were determined in μS/cm. The following conversion factor was used: μS/cm*0.64=mg/L. Thus, a 3000 mg/kg NaCl solution has a theoretical conductivity of 4687.5 S/cm.

Solution 1 was prepared in a 50 mL volumetric flask by dissolving approximately 0.15 g of NaCl in 50 mL of deionized water. A conductivity probe was placed in Solution 1 (3000 mg/kg solution) and a conductivity of 4084.9654 μS/cm was measured.

Solution 2 was prepared similarly to Solution 1 but with trace amounts of the extraction agent. Approximately 100 mL of deionized water was added to a separatory funnel and DPA was added to the funnel dropwise and shaken until two phases formed. Upon the formation of two phases, the aqueous phase was extracted. The solution was prepared in a 50 mL volumetric flask by dissolving 0.15 g NaCl in 50 mL of the extracted aqueous phase. The same conductivity probe was placed in Solution 2 and a conductivity of 8820.5951 μS/cm was measured.

Therefore, the difference in conductivity between Solution 1 and Solution 2 was ˜4000 μS/cm. This change in conductivity of ˜4000 μS/cm was used along with the conductivity of the water phase measured in Run 12 in order to calculate the compensated conductivity of the water phase in Run 12 and its respective NaCl concentration in mg/kg.

In Run 12, the conductivity of the water phase was measured as 4296.62 μS/cm. Based on the difference in conductivity between Solutions 1 and 2 (i.e., ˜4000 μS/cm) the compensated conductivity for Run 12 was: 4296.62 μS/cm-4000 μS/cm=296.62 μS/cm. This compensated conductivity for Run 12 results in a calculated NaCl concentration of the water phase in Run 12 of 189.84 mg/kg

### Example 2: Water Extractions from Simulated Seawater, Brackish Water, and Well Water

Two methods of extracting water from different aqueous solutions with different extraction agents were examined.

Method A: The extraction agent (100 mL) and the aqueous solution (100 mL) were mixed in a separatory funnel at ambient temperature for one (1) minute. A wet extraction agent phase (less dense; top layer) and a raffinate phase (more dense; bottom layer) were allowed to form and separate. The raffinate phase was removed and the wet extraction agent phase was transferred to a pear shaped flask. The wet extraction agent phase was heated to 80° C. for 5 minutes and the heated wet extraction agent phase formed a dry extraction agent phase (less dense; top layer) and a water phase (more dense; bottom layer). The water phase was recovered and its salt concentration was analyzed via atomic emission spectroscopy and/or gravimetric analysis. The dry extraction agent phase was suitable for reuse as extraction agent in subsequent runs.

Method B: The extraction agent (100 mL) and the aqueous solution (100 mL) were mixed in a separatory funnel at ambient temperature for one (1) minute. A wet extraction agent phase (less dense; top layer) and a raffinate phase (more dense; bottom layer) were allowed to form and separate. The raffinate phase was removed and the wet extraction agent phase was transferred to a graduated cylinder. The wet extraction agent phase was heated to 80° C. for 5 minutes and formed a heated extraction agent phase (less dense; top layer) and a heated aqueous solution phase (more dense; bottom layer). The heated extraction agent phase was removed while warm to provide a balanced mixture having a volume ratio of 1:1 of heated extraction agent phase to heated aqueous solution phase. The balanced mixture was cooled to ambient temperature and mixed for 1 minute. A cooled extraction agent phase (less dense; top layer) and a cooled aqueous solution phase (more dense; bottom layer) were allowed to form and separate. The cooled aqueous solution phase was removed. The cooled extraction phase was heated to 80° C. for 5 minutes and formed a dry extraction agent phase (less dense; top layer) and a water phase (more dense; bottom layer). The water phase was recovered and its salt concentration was analyzed via atomic emission spectroscopy and/or gravimetric analysis. The dry extraction agent phase and the recovered heated extraction agent phase were suitable for reuse as extraction agent in subsequent runs.

Simulated Aqueous Solutions: A seawater simulant was prepared having a concentration of sodium chloride of 35,064 mg/L. A brackish water simulant was prepared having a concentration of sodium of chloride of 4,090 mg/L. Additionally, various well water simulants having different salt concentrations were prepared based on various well water compositions in Egypt. The various well water simulants, along with their major ion concentrations and total dissolved solids (TDS), are set forth in Table 2a below.

TABLE 2A
Well water simulants.

| | Well | Well | Well | Well | Well | Well | Well | Well |
|---|---|---|---|---|---|---|---|---|
| | Water | Water | Water | Water | Water | Water | Water | Water |
| | # 1 | # 2 | # 3 | # 4 | # 5 | # 6 | # 7 | # 8 |
| Ca⁺ | 43.9 | 26.3 | 65.2 | 29.8 | 498.1 | 93.2 | 583.3 | 79.7 |
| (mg/L) | | | | | | | | |
| Mg²⁺ | 162.9 | 65.1 | 160.5 | 110.5 | 229.7 | 26.6 | 212.8 | 31.8 |
| (mg/L) | | | | | | | | |
| Na⁺ | 446.9 | 34.7 | 275.1 | 142.7 | 1191.5 | 335.4 | 1200.0 | 1020.0 |
| (mg/L) | | | | | | | | |
| K⁺ | 22.4 | 5.5 | 10.2 | 10.0 | 19.0 | 8.2 | 12.0 | 9.0 |
| (mg/L) | | | | | | | | |
| CO₃²⁻ | 6 | 22 | 6 | 12 | 3.8 | 11.2 | 6.0 | 9.0 |
| (mg/L) | | | | | | | | |
| HCO₃⁻ | 390.4 | 412.2 | 329.4 | 396.0 | 281.6 | 171.5 | 97.6 | 1340.2 |
| (mg/L) | | | | | | | | |
| SO₄²⁻ | 404.4 | 10.6 | 196.7 | 114.6 | 1307.6 | 439.1 | 1900.0 | 1085.0 |
| (mg/L) | | | | | | | | |
| Cl⁻ | 762.2 | 29.2 | 644.8 | 271.0 | 2359.4 | 355.9 | 2185.30 | 938.4 |
| (mg/L) | | | | | | | | |
| TDS | 2043.9 | 399.5 | 1523.2 | 888.7 | 5712 | 1381.2 | 6157 | 3258 |
| (mg/L) | | | | | | | | |

| | Well | Well | Well |
|---|---|---|---|
| | Water | Water | Water |
| | # 9 | #10 | # 11 |
| Ca⁺ | 471.0 | 465.8 | 126.7 |
| (mg/L) | | | |
| Mg²⁺ | 290.0 | 58.61 | 44.21 |
| (mg/L) | | | |
| Na⁺ | 900.0 | 800 | 720 |
| (mg/L) | | | |
| K⁺ | 23.0 | 7 | 11 |
| (mg/L) | | | |
| CO₃²⁻ | 0.0 | 12 | 9 |
| (mg/L) | | | |
| HCO₃⁻ | 30.0 | 228.75 | 125.05 |
| (mg/L) | | | |
| SO₄²⁻ | 181.0 | 1964 | 1015 |
| (mg/L) | | | |
| Cl⁻ | 2900.0 | 719.86 | 668.44 |
| (mg/L) | | | |
| TDS | 4795 | 4141 | 2657 |
| (mg/L) | | | |

Extraction Agents: Both dipropylamine and di-iso-propylamine were used as extraction agents. In Table 4 below, dipropylamine is referred to as “DPA” and di-iso-propylamine is referred to as “DIPA”.

Atomic Absorption Analysis: The atomic absorption analysis was performed on a Buck Scientific 210 VGP Atomic Absorption Spectrophotometer in Emission mode.

Gravimetric Analysis: For gravimetric analysis, the recovered water phase (or well water simulant or raffinate phase) was dried in an oven at 66° C. until the water was removed and only salt remained. The mass of the remaining salt was determined and used to calculate the salt concentration of the water phase.

The results of Example 2 (i.e., Runs 13-29) are set forth below in Table 2B.

TABLE 2B
Salt removal and TDS of recovered water phases.

| | | | Simulated | Salt | |
|---|---|---|---|---|---|
| | Extraction | | Aqueous | Removal | TDS |
| Run # | Agent | Method | Solution | (%)² | (mg/L)³ |
| 13 | DPA | A | Seawater | 86.80 | 4,630 |
| 14 | DPA | B | Seawater | 98.80 | 420 |
| 15 | DIPA | A | Seawater | 78.00 | 7,700 |
| 16 | DIPA | B | Seawater | 95.72 | 1,500 |
| 17 | DPA | A | Brackish | 90.71 | 380 |
| 18 | DIPA | A | Brackish | 81.42 | 760 |
| 19 | DPA | A | Well Water 1 | 84.34 | 457.14 |
| 20 | DPA | A | Well Water 2 | 96.12 | 35.29 |
| 21 | DPA | A | Well Water 3 | 89.11 | 294.12 |
| 22 | DPA | A | Well Water 4 | 81.61 | 320.00 |
| 23 | DPA | A | Well Water 5 | 93.20 | 475.00 |
| 24 | DPA | A | Well Water 6 | 95.17 | 77.78 |
| 25 | DPA | A | Well Water 7 | 96.00 | 320 |
| 26 | DPA | A | Well Water 8 | 97.02 | 100 |
| 27 | DPA | A | Well Water 9 | 88.72 | 600 |
| 28 | DPA | A | Well Water 10 | 98.47 | 90.0 |
| 29 | DPA | A | Well Water 11 | 99.12 | 30.0 |

²Salt removal (%) represents the percentage of salt removed from the simulated aqueous solution. For seawater and brackish water simulants, salt removal (%) was calculated via atomic absorption analysis. For well water simulants, salt removal (%) was calculated via gravimetric analysis.
³For seawater and brackish water simulants, TDS was calculated via atomic absorption analysis. For well water simulants, TDS was calculated via gravimetric analysis.

For each run, greater than 75% of salt was removed from the simulated aqueous solution. Moreover, Run 14 and Run 16 indicate that the balancing step may be particularly beneficial in increasing the amount of salt removed from the aqueous solutions. The results demonstrate that the methods may be suitable for extracting agricultural and/or potable water from aqueous solutions.

### Example 3: Simulated Well Water Extractions Using Semi-Permeable Membrane

### Preparation of Simulated Well Water Solutions:

For each of the simulated well water solutions, the amounts of salts set forth in Table 3A were measured using an OHaus Pioneer mass balance and added to a 1 L volumetric flask. About 700 mL of deionized water was added to the flask, and the flask was inverted and swirled at least 3× or until all salts were dissolved. The flask was then filled with deionized water to give a 1 L final volume.

TABLE 3A
Simulated well water solution formulations.

| | | | | | | | Total |
|---|---|---|---|---|---|---|---|
| | MgCl₂ | CaCl₂ | CaCO₃ | KHCO₃ | Na₂SO₄ | NaHCO₃ | Dissolved |
| Simulated | (g/1000 | (g/1000 | (g/1000 | (g/1000 | (g/1000 | (g/1000 | Salts |
| Well | mL | mL | mL | mL | mL | mL | (TDS) |
| Water | H₂O) | H₂O) | H₂O) | H₂O) | H₂O) | H2O) | (mg/L) |
| Miocene-1 | 0.83 | 0.97 | 1.46 | 0.03 | 2.81 | 3.32 | 9525 |
| Miocene-7 | 0.12 | 0.15 | 0.20 | 0.02 | 1.60 | 1.90 | 3994 |
| Miocene-33 | 1.14 | 1.32 | 1.18 | 0.06 | 0.27 | 0.32 | 4280 |
| Quaternary | 0.23 | 0.27 | 1.16 | 0.02 | 2.90 | 3.44 | 8018 |
| Aquifer | | | | | | | |
| No. 14 | | | | | | | |
| Quaternary | 0.17 | 0.20 | 0.32 | 0.03 | 1.50 | 1.78 | 3996 |
| Aquifer | | | | | | | |
| No. 18 | | | | | | | |
| Quaternary | 0.15 | 0.17 | 0.30 | 0.30 | 1.48 | 1.75 | 3871 |
| Aquifer | | | | | | | |
| No. 25 | | | | | | | |

### Water Extraction Method Using Semi-Permeable Membrane:

A 15 cm length of 3 inch 12-14 kDa dialysis membrane was placed in deionized water to rehydrate for 10 minutes. One end of the hydrated membrane was sealed using an umbilical clip to form an open ended sack. The membrane was filled with 100 mL of DPA (recycled from prior water extractions from 0.6M NaCl solutions and likely contaminated with residual NaCl) and sealed using a second umbilical clip. The filled membrane was placed into a clean 1 L beaker. The beaker was then filled with 1 L of the simulated well water (as described in Table 3A). If the filled membrane floated, it was manually submerged using a clean beaker partially filled with deionized water. The membrane was submerged in the simulated well water for 60 minutes, suspended over a clean 500 mL beaker and carefully drained to avoid transferring simulated well water into the 500 mL beaker. The wet extraction agent (the top layer) was removed and added to a 250 mL flask, and osmotic water was removed via pipette. The mass of the wet extraction agent was measured, a temperature probe was added to the flask, and the wet extraction agent was heated in a 95° C. water bath until reaching a temperature of 80° C. The flask was removed from the bath, cooled to ambient temperature, and the water layer removed via a 5 mL graduated pipette. The masses of the removed water and the remaining (dry) extraction agent were measured and the liquids underwent further gravimetric analyses according to the procedure set forth in Example 1.

TABLE 3B
Results of water extractions.

| | TDS of | TDS of | | | |
|---|---|---|---|---|---|
| | Feed | Feed | TDS of | | TDS |
| | Solution | Solution | Recovered | Water | Salt |
| | Calculated | Actual | Solution | Recovery | Removal |
| Name | (mg/L) | (mg/L) | (mg/L) | (%) | (%) |
| Miocene-1 | 9425.34 | 9426.40 | 2200.00 | 0.90 | 71.95 |
| Miocene-7 | 3993.92 | 3993.90 | 628.57 | 1.05 | 78.22 |
| Miocene-33 | 4279.55 | 4279.50 | 1871.43 | 1.12 | 58.61 |
| Quaternary | 8017.61 | 8017.20 | 842.86 | 1.00 | 95.40 |
| Aquifer No. 14 | | | | | |
| Quaternary | 3995.76 | 3995.50 | 600.00 | 1.10 | 79.81 |
| Aquifer No. 18 | | | | | |
| Quaternary | 3870.60 | 3870.50 | 824.29 | 0.75 | 70.71 |
| Aquifer No. 25 | | | | | |

### Example 4: Water Extractions from NaCl Solutions Using Semi-Permeable Membrane and Extraction Agents

### Preparation of 0.6M NaCl Solution:

35.06 g of NaCl was added to a 1 L volumetric flask. To the flask was added about 700 mL of deionized water, the flask was inverted and swirled at least 3× or until the salt was completely dissolved. Deionized water was added to the flask to give a final volume of 1 L.

### Water Extraction Method:

The water extraction method set forth in Example 3 was followed for these water extractions, in each instance, extracting water from the 0.6M NaCl solution using the extraction agent set forth in Table 4. The extracted water and extraction agent were analyzed using gravimetric analysis following the procedures set forth in Example 1.

TABLE 4
Results of water extractions.

| | | | Feed Solution | | |
|---|---|---|---|---|---|
| | | Water | NaCl | NaCl | NaCl |
| | Extraction | Recovery | Concentration | Concentration | Removal |
| Extraction | Agent | (%) | (mg/L) | (mg/L) | (%) |
| 1 | Diethylamine | 0.0 | 35064 | N/A | N/A |
| 2 | Diethylamine | 0.0 | 35064 | N/A | N/A |
| 3 | Dipropylamine | 0.76 | 35064 | 3127.5294 | 91.08 |
| 4 | Dipropylamine | 0.96 | 35064 | 4334.1659 | 87.64 |
| 5 | Dibutylamine | 0.11 | 35064 | 5540.8024 | 84.20 |
| 6 | Dibutylamine | 0.12 | 35064 | 7501.5867 | 78.61 |
| 7 | Diamylamine | 0.05 | 35064 | 8859.0527 | 74.73 |
| 8 | Diamylamine | 0.04 | 35064 | 18361.3152 | 47.63 |

### Example 5: Water Extractions from NaCl Solutions Using Semi-Permeable Membrane and Octanoic Acid

Preparation of 0.6M NaCl Solution: 35.064 g of NaCl was added to a Class B 1 L volumetric flask. To the flask was added about 700 mL of deionized water, the flask was inverted and swirled at least three (3) times or until the salt was completely dissolved. Deionized water was added to the flask to give a final volume of 1 L.

Water Extraction Method: The water extraction method set forth in Example 3 was generally followed for these water extractions except for as provided in Table 5A. In each instance, water was extracted from the 0.6M NaCl solution using octanoic acid. The extracted water and extraction agent were analyzed using gravimetric analysis following the procedures set forth in Example 1. The results are provided in Table 5B.

TABLE 5A
Extraction protocols.

| Extraction | Protocol |
|---|---|
| 1 | Same as Example 3. |
| 2 | Same as Example 3, except that the membrane was |
| | submerged in the simulated well water for 60 minutes |
| | at a temperature of 80° C. and the saturated |
| | extraction agent was cooled to 0° C. to separate |
| | the water layer from the extraction agent. The |
| | separated layers were allowed to warm to room |
| | temperature before separating the water layer from |
| | the extraction agent. |
| 3 | Same as Example 3, except that the membrane was |
| | submerged in the simulated well water for 60 minutes |
| | at a temperature of 80° C. and the saturated |
| | extraction agent was cooled to room temperature to |
| | separate the water layer from the extraction agent. |
| 4 | Same as Extraction 1 except that excess 0.6M NaCl |
| | solution that migrated across the membrane was removed |
| | prior to heating the saturated extraction agent. |
| 5 | Same as Extraction 3 except that excess 0.6M NaCl |
| | solution that migrated across the membrane was removed |
| | prior to cooling the saturated extraction agent. |

TABLE 5B
Results of water extractions.

| | | | Feed Solution | | |
|---|---|---|---|---|---|
| | | Water | NaCl | NaCl | NaCl |
| | Extraction | Recovery | Concentration | Concentration | Removal |
| Extraction | Agent | (%) | (mg/L) | (mg/L) | (%) |
| 1 | Octanoic Acid | 0.32 | 35064 | >35064 | 0.00 |
| 2 | Octanoic Acid | 0.16 | 35064 | 27,439.92 | 20 |
| 3 | Octanoic Acid | 0.17 | 35064 | 30,856.32 | 12.00 |
| 4 | Octanoic Acid | 0.030 | 35064 | 18583.92 | 47.00 |
| 5 | Octanoic Acid | 0.060 | 35064 | 18233.28 | 48.00 |

The results demonstrate that octanoic acid may be used as an extraction agent to remove NaCl from aqueous solutions.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for extracting water from an aqueous solution comprising:
a reservoir comprising
an inlet configured to provide a feed stream comprising an extraction agent and the aqueous solution to the reservoir under mixing conditions, at about ambient temperature, to form a wet extraction agent phase and a raffinate phase, wherein the aqueous solution has a concentration of sodium chloride;
a lower outlet, wherein the lower outlet is reversibly closable and configured to permit at least a portion of the raffinate phase to exit the reservoir while retaining from about 50% to about 100% by volume of the wet extraction agent phase in the reservoir;
a heater configured to heat the wet extraction agent phase to a temperature of from about 40° C. to about 110° C. to form a heated mixture comprising a dry extraction agent phase and a water phase; and
an upper outlet, wherein the upper outlet fluidly communicates with a channel configured to permit at least a portion of the dry extraction agent phase to return to the feed stream.

2. The system of claim 1, wherein the lower outlet is spatially oriented on the reservoir so that the lower outlet is below the upper outlet.

3. The system of claim 1 or claim 2, wherein the upper outlet is reversibly closable.

4. The system of any one of claims 1-3, wherein the lower outlet comprises a reversibly closable valve.

5. The system of claim 4, wherein the reversibly closable valve of the lower outlet comprises a solenoid configured to open the reversibly closable valve when power is supplied to the solenoid and close when power is not supplied to the solenoid.

6. The system of claim 4, wherein the reversibly closable valve comprises a spring-operated cap, wherein the spring-operated cap is configured to assume an open position when pressure inside the reservoir reaches a threshold.

7. The system of any one of claims 1-6, wherein the channel comprises a conduit, wherein at least a portion of the conduit comprises a semi-permeable membrane.

8. The system of any one of claims 1-7, further comprising a pump fluidly communicating with the upper outlet and the channel, wherein the pump is configured to move at least a portion of the dry extraction agent phase from the reservoir into the channel.

9. A system for extracting water from an aqueous solution comprising:
a source of aqueous solution, wherein the aqueous solution comprises a concentration of sodium chloride; and
an extraction loop comprising
an extraction agent,
a conduit comprising a semi-permeable segment and a non-permeable segment, wherein the conduit is configured to permit the flow of at least a portion of the extraction agent through the semi-permeable segment and the non-permeable segment, and wherein at least a portion of the semi-permeable segment contacts the source of aqueous solution and is configured to permit a portion of the aqueous solution to contact at least a portion of the extraction agent,
a heater thermally communicating with a portion of the extraction agent within a heated portion of the non-permeable segment, wherein the heater is configured to heat the portion of extraction agent thermally communicating therewith from ambient temperature to a temperature of from about 40° C. to about 110° C. to form an extraction agent phase and a water phase;
a reversibly closable water outlet fluidly communicating with a portion of the non-permeable segment and oriented downstream from the heater, wherein the water outlet is configured to permit at least a portion of the water phase to exit the conduit while retaining from about 50% to about 100% by volume of the extraction agent phase in the conduit,
wherein the extraction loop is configured to return at least a portion of the extraction agent phase to the semi-permeable segment of the conduit as extraction agent.

10. The system of claim 9, wherein the semi-permeable segment comprises a plurality of pores having a mean pore size of from about 80 nm to about 1 μm.

11. The system of claim 9 or claim 10, wherein the semi-permeable segment comprises a porosity giving a molecular weight cut off of from about 300 D to about 3,000 D.

12. The system of any one of claims 9-11, wherein the semi-permeable segment comprises a cellulose material, a polysulphone material, a polyamide material, a polyimide material, PTFE, PVDF, PEO, PPO, PVC, CPVC, PP, HDPE, PE, or any combination thereof.

13. The system of any one of claims 9-12, wherein a portion of the non-permeable segment downstream from the heater is configured to permit the extraction agent phase to cool to a temperature of from about ambient temperature to about 34° C. before reaching the semi-permeable segment.

14. The system of any one of claims 9-13, wherein a portion of the non-permeable segment downstream from the heater comprises a tank, wherein the reversibly closable water outlet fluidly communicates with the tank, and wherein the tank fluidly communicates with the heated portion of the non-permeable segment.

15. The system of any one of claims 9-14, further comprising an actuator fluidly communicating with the extraction loop and configured to cycle the extraction agent and the extraction phase around the extraction loop.

16. The system of claim 15, wherein the actuator comprises a pump.

17. A system for extracting water from an aqueous solution comprises an extraction loop and an extraction agent, wherein the extraction loop comprises a membrane interface, a heater, a cooler, and a separation tank,
the membrane interface comprises a semi-permeable membrane interposed between a source of aqueous solution and the extraction agent, wherein the semi-permeable membrane is configured to permit a portion of the aqueous solution to permeate through the membrane interface and mix with dry extraction agent forming wet extraction agent;
the heater is a regenerative heat exchanger configured to convey heat from dry extraction agent to wet extraction agent in the extraction loop;
the cooler is upstream from membrane interface and is configured to convey heat from dry extraction agent to a feed stream of aqueous solution; and
the separation tank is configured to allow the wet extraction agent to settle into a bi-phasic mixture comprising a water layer and a dry extraction agent layer, wherein the separator tank comprises a water outlet.

18. The system of claim 17, further comprising a pump configured to pump aqueous solution from a source of aqueous solution creating the feed stream of aqueous solution wherein the feed stream contacts the membrane interface, flows through the cooler, and is returned to the source of aqueous solution.

19. The system of claim 17 or claim 18, further comprising a plurality of pumps configured in the extraction loop to convey wet extraction agent from the membrane interface to the heater, convey wet extraction agent from the heater to the separation tank, convey dry extraction agent from the separation tank to the cooler, and convey dry extraction agent from the cooler to the membrane interface.

20. The system of any one of claims 17-19, wherein the heater is configured to generate a heated wet extraction agent having a temperature of from about 50° C. to about 65° C.

21. The system of any one of claims 17-20, wherein the extraction loop further comprises a solar array configured downstream from the heater and upstream from the separation tank, wherein the solar array operates cooperatively with the heater to heat the wet extraction agent.

22. The system of any one of claims 17-21, wherein the extraction loop further comprises an extraction agent tank, wherein the extraction agent tank is downstream from the separation tank and upstream from the cooler, and the extraction agent tank comprises a drain.

23. The system of any one of claims 17-22, wherein the extraction loop further comprises a filter fluidly communicating with the water outlet of the separator tank.

24. The system of claim 23, wherein the filter comprises a granulated activated carbon bed.
